(19) United States
(12) Patent Application Publication
(10) Pub. No.: US 2013/0073625 A1
(43) Pub. Date: Mar. 21, 2013

(54) INFORMATION PROCESSING APPARATUS, EVENT CONTROL METHOD, AND COMPUTER-READABLE NON-TRANSITORY RECORDING MEDIUM

(71) Applicants: Yoshiaki UMETSU, Kahoku-shi (JP); Chieko MURAI, Kahoku-shi (JP); Takashi KUBOTA, Kahoku-shi (JP)

(72) Inventors: Yoshiaki UMETSU, Kahoku-shi (JP); Chieko MURAI, Kahoku-shi (JP); Takashi KUBOTA, Kahoku-shi (JP)

(73) Assignee: PFU LIMITED, Kahoku-shi (JP)

(21) Appl. No.: 13/555,629

(22) Filed: Jul. 23, 2012

(30) Foreign Application Priority Data
Sep. 20, 2011 (JP) 2011-204685

(51) Int. Cl. G06F 15/16

(52) U.S. Cl. 709/204

(57) ABSTRACT

The event control module acquires user information including any of a user attribution, user position information, and a user association state, determines whether or not the user attribution, the user position information, and the user association state satisfy an event generation condition, and allows or instructs the generation of an event when the event generation condition is determined to be satisfied.

### CROSS-REFERENCE TO RELATED APPLICATION

This application is based upon and claims the benefit of priority of the prior Japanese Patent Application No.JP2011-204685, filed on Sep. 20, 2011, the entire contents of which are incorporated herein by reference.

### FIELD

The present disclosure relates to an event control technique.

### BACKGROUND

A system for implementing proximity- or location-driven activities in which a request to interact is executed when a person, an object, or a group of persons or objects arrives at a target position or comes close thereto has been suggested (see Japanese Translation of PCT Application No. 2005-509198).

An access control method that allows a user to access stored information only when the present geographical position acquired by a GPS (Global Positioning System) is an allowed geographical position (see Japanese Patent Application Publication No. 2000-163379) and an encrypting system including positional information in which a region in which a file can be accessed is set in the file itself (see Japanese Patent Application Publication No. 2007-241907) have also been suggested.

A system, in which contact contents including the GPS identifier and status associated with members of a social network found at the same or substantially same location appear on a GPS-equipped device, has also been suggested (see Japanese Translation of PCT Application No. 2010-520540).

### SUMMARY

The information processing apparatus according to the present disclosure is provided with a user information acquisition unit to acquire user information including at least any one of user attribution information, position information indicating a present position of the user, and a state of a predetermined user association to which the user belongs; a determination unit to determine whether or not the attribution information, the position information, and the state of the predetermined user association satisfy a condition associated with a predetermined event; and an event control unit to allow or instruct generation of the predetermined event when the condition is determined by the determination unit to be satisfied.

Further, the present disclosure can be understood as an event control method for causing a computer to execute: acquiring user information including at least any one of user attribution information, position information indicating a present position of the user, and a state of a predetermined user association to which the user belongs; determining whether or not the attribution information, the position information, and the state of the predetermined user association satisfy a condition associated with a predetermined event; and allowing or instructing generation of the predetermined event when the condition is determined in the determining to be satisfied.

Still further, the present disclosure can be understood as an event control program for causing a computer to function as: a user information acquisition unit to acquire user information including at least any one of user attribution information, position information indicating a present position of the user, and a state of a predetermined user association to which the user belongs; a determination unit to determine whether or not the attribution information, the position information, and the state of the predetermined user association satisfy a condition associated with a predetermined event; and an event control unit to allow or instruct generation of the predetermined event when the condition is determined by the determination unit to be satisfied.

### BRIEF DESCRIPTION OF THE DRAWINGS

FIG. 1 illustrates schematically the system configuration according to the embodiment;

FIG. 2 illustrates schematically the software configuration of the event control module according to the embodiment;

FIG. 3A illustrates schematically the functional configuration of the event registration terminal according to the embodiment;

FIG. 3B illustrates schematically the functional configuration of the user terminal according to the embodiment;

FIG. 3C illustrates schematically the functional configuration of the event control module according to the embodiment;

FIG. 4 illustrates the configuration of the event generation condition that is used in the embodiment;

FIG. 5 illustrates the phases of processing in the system according to the embodiment;

FIG. 6 illustrates schematically the event generation processing according to the embodiment;

FIG. 7 illustrates an example of the event information generated in the embodiment;

FIG. 8 illustrates schematically the event registration processing according to the embodiment;

FIG. 9 illustrates schematically the user information acquisition processing according to the embodiment;

FIG. 10 illustrates an example of user attribution that is acquired by the SNS information acquisition unit of the user terminal in the embodiment;

FIG. 11 illustrates by way of example a mode in which the user information is acquired by a plurality of user terminals and transmitted to the event control module in the embodiment;

FIG. 12 illustrates an example of user information acquired by the event control module in the embodiment;

FIG. 13 illustrates schematically the event generation determination processing according to the embodiment;

FIG. 14 is a flowchart illustrating the event generation condition determination processing according to the present disclosure;

FIG. 15 illustrates an example of the event generation condition determination result according to the embodiment;

FIG. 16 illustrates schematically the event generation processing according to the embodiment;

FIG. 17 illustrates an example of event generation mode for each user terminal according to the embodiment;

FIG. 18 illustrates a variation of event registration;

FIG. 19 illustrates schematically the functional configuration of the event control module in the variation;

FIG. 20 illustrates a mode of event generation in the case where an event is generated in the storage;

FIG. 21 illustrates schematically the functional configuration of the event control module in the variation;

FIG. 22 illustrates a mode of event generation in the case where an event is generated in the user terminal;

FIG. 23 illustrates schematically the functional configuration of the event control module in the variation;

FIG. 24 illustrates a mode of event generation in the case where an event is generated in the event control module;

FIG. 25 illustrates schematically the functional configuration of the event control module in the variation;

FIG. 26 illustrates an example in which the system according to the embodiment is applied to a game system in which a plurality of users is connected to each other by a network by using user terminals and play simultaneously;

FIG. 27A illustrates an example of event information that is registered when the system according to the embodiment is applied to a game system;

FIG. 27B illustrates an example of event information that is registered when the system according to the embodiment is applied to a game system;

FIG. 27C illustrates an example of event information that is registered when the system according to the embodiment is applied to a game system;

FIG. 27D illustrates an example of event information that is registered when the system according to the embodiment is applied to a game system;

FIG. 28 illustrates an example of event information that is registered in the case where the system according to the embodiment is applied to a system linked to a local community;

FIG. 29 illustrates an event generation status in the case where the system according to the embodiment is operated;

FIG. 30 illustrates an example of event information that is registered when the system according to the embodiment is applied to an orienteering system;

FIG. 31 illustrates the event generation status in the case where the system according to the embodiment is operated;

FIG. 32A illustrates an example of event information registered in the case where the system according to the embodiment is applied to a meeting management system;

FIG. 32B illustrates an example of event information registered in the case where the system according to the embodiment is applied to a meeting management system;

FIG. 33A illustrates an example of event information registered in the case where the system according to the embodiment is applied to a shared notebook system;

FIG. 33B illustrates an example of event information registered in the case where the system according to the embodiment is applied to a shared notebook system;

FIG. 33C illustrates an example of event information registered in the case where the system according to the embodiment is applied to a shared notebook system; and

FIG. 34 illustrates an example of event information registered in the case where the system according to the embodiment is applied to an information distribution system.

### DESCRIPTION OF EMBODIMENTS

The embodiments of the information processing apparatus, event control method, and event control program in accordance with the present disclosure will be explained below with reference to the appended drawings. The embodiments explained hereinbelow are exemplary embodiments, and the information processing apparatus, event control method, and event control program according to the present disclosure are not limited to the specific configuration explained hereinbelow. The specific configurations corresponding to the embodiments may be used as appropriate during the implementation.

In the present embodiment, the information processing apparatus according to the present disclosure is realized as an event control module 1. However, the application of the present disclosure is not limited to the system explained in the present embodiment, provided that the system performs the event control by using position information. For example, the information processing apparatus may be realized as a system in which the event control is performed by a user terminal 5.

The event as referred to in the present embodiment is generated under specific conductions and defined by event information 9. The event information 9 includes an event generation condition 93 that is a condition imposed for event generation and has been set in advance, event contents storage destination information 92 indicating the storage destination of event contents 91, and the event contents 91 indicating the processing that is wished to be generated as an event (see FIG. 7 or the like).

The event contents 91 mentioned herein are information describing the contents of the event that is to be generated, and the format of the description is not limited and can vary depending on the embodiments. The event contents 91 may be, for example, software itself that is executed for event generation or an instruction (command) issued with respect to the function of executing an event. Further, the event contents storage destination information 92 is a pointer indicating a storage 2 where the event contents 91 are stored. The event generation condition 93 and the event contents storage destination information 92 are also not limited and the format of description thereof can be used as appropriate according to the embodiment.

### <System Configuration>

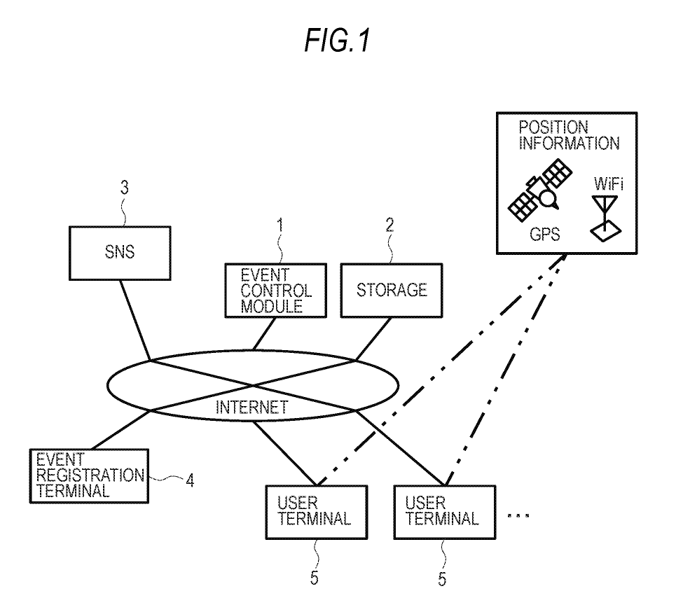

FIG. 1 illustrates schematically the system configuration of the present embodiment. In the system according to the present embodiment, an event control module 1, the storage 2, a SNS (Social Network Service) 3, an event registration terminal 4, and the user terminal 5 are connected to each other via a network such as Internet. The event control module 1 and the storage 2 may be configured as separate servers or may be configured as a single server. The event registration terminal 4 may be the same as the user terminal 5. For example, when a certain user is a participant of a conference and also a host, the terminal of this user serves as both the event registration terminal 4 and the user terminal 5.

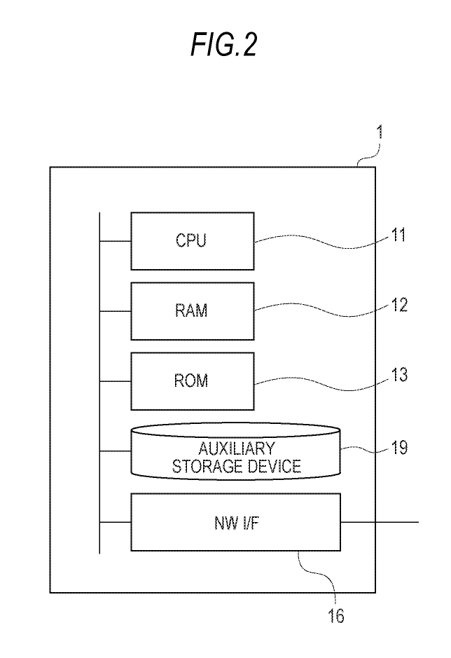

FIG. 2 illustrates schematically the software configuration of the event control module 1 of the present embodiment. The event control module 1 is an information processing apparatus in which a CPU (Central Processing Unit) 11, a RAM (Random Access Memory) 12, a ROM (Read Only Memory) 13, an auxiliary storage device 19, and a network interface 16 for performing communication with the external objects via a network are electrically connected. Concerning the specific hardware configuration of the information processing apparatus, the constituting elements thereof may be omitted, replaced, or added as appropriate according to a specific embodiment.

The CPU 11 is a central processing unit that processes commands and data loaded into the RAM 12 and the ROM 13, thereby controlling the components provided in the event control module 1, such as the RAM 12 and the auxiliary storage device 19. The RAM 12 is a main storage device that is controlled by the CPU 11 and has commands and data written therein and read therefrom. Thus, the CPU 11, the RAM 12, and the ROM 13 constitute control units of the event control module 1.

The auxiliary storage device 19 is a nonvolatile storage device that is mainly used for writing and reading information that is wished to be stored even when the power supply of the event control module 1 is cut off. Examples of such information include an OS (Operating System) of the event control module 1 that is loaded into the RAM 12, various programs for executing the below-described processing, and various data that are used by the event control module 1. For example, an EEPROM (Electrically Erasable Programmable ROM) or a HDD (Hard Disk Drive) can be used as the auxiliary storage device 19.

The storage 2, the SNS 3, the event registration terminal 4, and the user terminal 5 are computer systems (not shown in the figure) provided, similarly to the event control module 1, with a CPU, a RAM, a ROM, an auxiliary storage device, and a network interface, which constitute a typical computer.

Various servers such as the event control module 1, the storage 2, and the SNS 3 may be installed as a cloud service on the network. In this case, the main objects of processing with the servers is a plurality of machines dispersed on the network, but in the present embodiment, a plurality of machines for realizing the functions of a server is collectively called a “server”.

In addition to the configuration serving as a typical computer explained hereinabove, the user terminal 5 is also provided with a configuration for acquiring position information 8b indicating the present position of the user terminal 5. For example, a module that acquires the position information 8b of the user terminal 5 by a GPS, or a module that acquires the position information 8b of the user terminal 5 from the position information 8b of a communicable radio LAN (Wi-Fi) access point may be used as the configuration for acquiring the position information 8b. Depending on a means for using the position information 8b of the radio LAN access point, more specific position information 8b, such as the number of floors in the building, can be obtained in addition to the latitude and longitude. Other means may be also used in the configuration for obtaining the position information 8b. A plurality of means, from among means including a means for using a GPS and a means for using the position information 8b of a radio LAN access point, may be used in a combination.

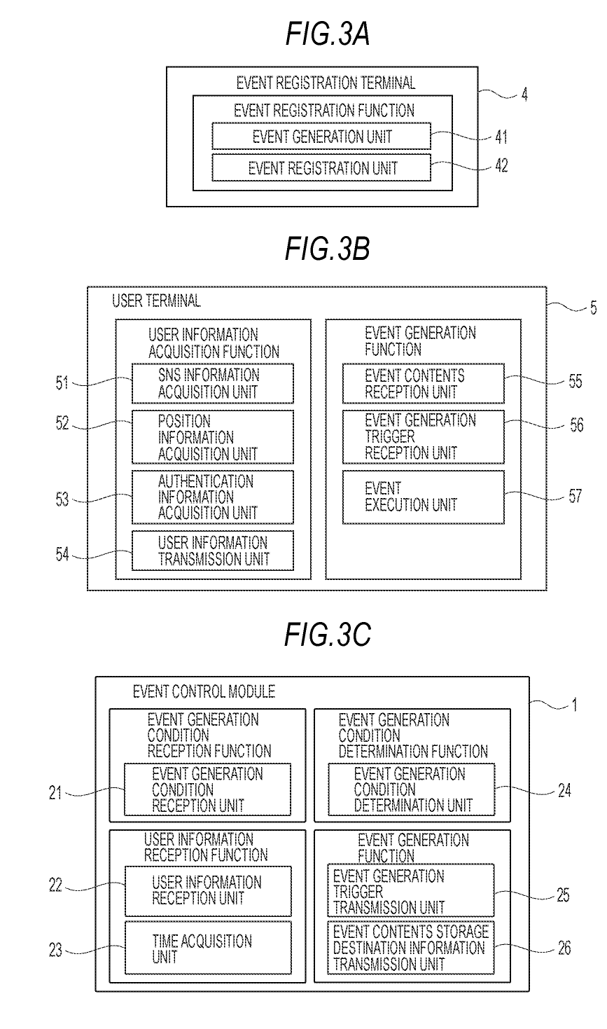

The functions of each terminal constituting the present system will be explained below. FIG. 3A to FIG. 3C illustrate schematically the functional configuration of the system according to the present embodiment.

FIG. 3A illustrates schematically the functional configuration of the event registration terminal 4 according to the present embodiment. The event registration terminal 4 is a terminal for registering the event information 9 in the system and includes an event generation unit 41 that generates the event information 9 including the event generation condition 93, the event contents storage destination information 92, and the event contents 91, and an event registration unit 42 that registers the generated event information 9 in the event control module 1 or the storage 2. More specifically, the event registration unit 42 registers the event generation condition 93 and the event contents storage destination information 92 in the event control module 1 and stores the event contents 91 in the storage 2 indicated in the event contents storage destination information 92. For example, a PC (Personal Computer), a cellular phone, a smartphone, a tablet terminal, a portable game machine, etc., can be used as the event registration terminal 4.

The storage 2 is provided with an event contents storage unit (not shown in the figure) that receives and stores the event contents 91. For example, a cloud storage, a server, etc., can be used as the storage 2.

FIG. 3B illustrates schematically the functional configuration of the user terminal 5 according to the present embodiment. The user terminal 5 is a terminal by which the user receives the event information 9. This terminal is provided with a user information acquisition function of acquiring user's information and transmitting the acquired information to the event control module 1 and an event generation function of generating an event. More specifically, the user terminal 5 is provided with a SNS information acquisition unit 51 that acquires information relating to the user on the SNS 3, a position information acquisition unit 52 that acquires the position information 8b on the present position of the user terminal 5, an authentication information acquisition unit 53 that acquires authentication information 8e, a user information transmission unit 54 that transmits the acquired information to the event control module 1, an event contents reception unit 55 that receives the event contents 91 from the storage 2, an event generation trigger reception unit 56 that receives an event generation trigger from the event control module 1, and an event execution unit 57 that receives the event generation trigger and executes the event according to the event contents 91. The user information acquisition function is realized by the SNS information acquisition unit 51, the position information acquisition unit 52, the authentication information acquisition unit 53, and the user information transmission unit 54, and the event generation function is realized by the event contents reception unit 55, the event generation trigger reception unit 56, and the event execution unit 57 from among the above-mentioned units (see FIG. 3B). For example, a PC, a cellular phone, a smartphone, a tablet terminal, and a portable game machine can be used as the user terminal 5.

The event generation object may be other than the user terminal 5. The configuration and processing relating to the case where an event is generated outside the user terminal 5 will be explained below. In the case where the user terminal 5 is also used as the event registration terminal 4, the user terminal 5 is provided with the functions of the above-described user terminal 5 and also the functions of the event registration terminal 4.

FIG. 3C illustrates schematically the functional configuration of the event control module 1 according to the present embodiment. The event control module 1 has an event registration function, a user information reception function, an event generation condition determination function, and an event generation function and determines whether or not each user satisfies the event generation condition 93 on the basis of the event generation condition 93 and the user information 8. More specifically, the event control module 1 according to the present embodiment functions as an information processing apparatus including an event generation condition reception unit 21, a user information reception unit 22, a time acquisition unit 23, an event generation condition determination unit 24, an event generation trigger transmission unit 25, and an event contents storage destination information transmission unit 26 by interpreting and executing various programs loaded into the RAM 12 by the CPU 11 (see FIG. 3C). Further, in the present embodiment, an example is explained when all those functions are executed by the general-use CPU 11, but some or all of those functions may be also realized by one or a plurality of special processors. Further, the event control module 1 may be installed, for example, on a cloud, a server, or the user terminal 5.

The event generation condition reception unit 21 receives the event generation condition 93 and the event contents storage destination information 92 from the event registration terminal 4.

The user information reception unit 22 receives the user information 8 from the user terminal 5. In this case, the user information 8 includes at least a user attribution 8a, position information 8b indicating the present position of the user, a state 8c of a predetermined user association to which the user belongs (referred to hereinbelow as “association state”), a present time 8d, and user authentication information 8e. For example, the association state 8c indicates the number of users for which the user attribution 8a or position information 8b satisfy the predetermined condition in the association of users including other users, and whether or not the position information 8b of the predetermined user satisfies the predetermined conditions. Such information can be obtained on the basis of the user attribution 8a or position information 8b of other users.

The time acquisition unit 23 acquires the present time 8d. The present time 8d may be also acquired by the user terminal 5 and transmitted to the event control module 1, but in the present embodiment, the present time 8d acquired by the time acquisition unit 23 of the event control module 1 is used as the user information 8. As a result, the user can be prevented from wrongly generating an event, for example, by changing the time setting of the user terminal 5.

The event generation condition determination unit 24 determines whether or not each user satisfies the event generation condition 93 on the basis of the event generation condition 93 and the user information 8. More specifically, the event generation condition determination unit 24 determines whether or not the user attribution 8a, the position information 8b, the association state 8c, the present time 8d, and the authentication information 8e included in the user information 8 satisfy an attribution condition 93a, a location condition 93b, an association state condition 93c, a time condition 93d, and an authentication condition 93e included in the event generation condition 93 associated with the event. In this case, each condition may be set differently for each user or each combination of users. For example, in the location condition 93b, a different location can be set for each user or each combination of users.

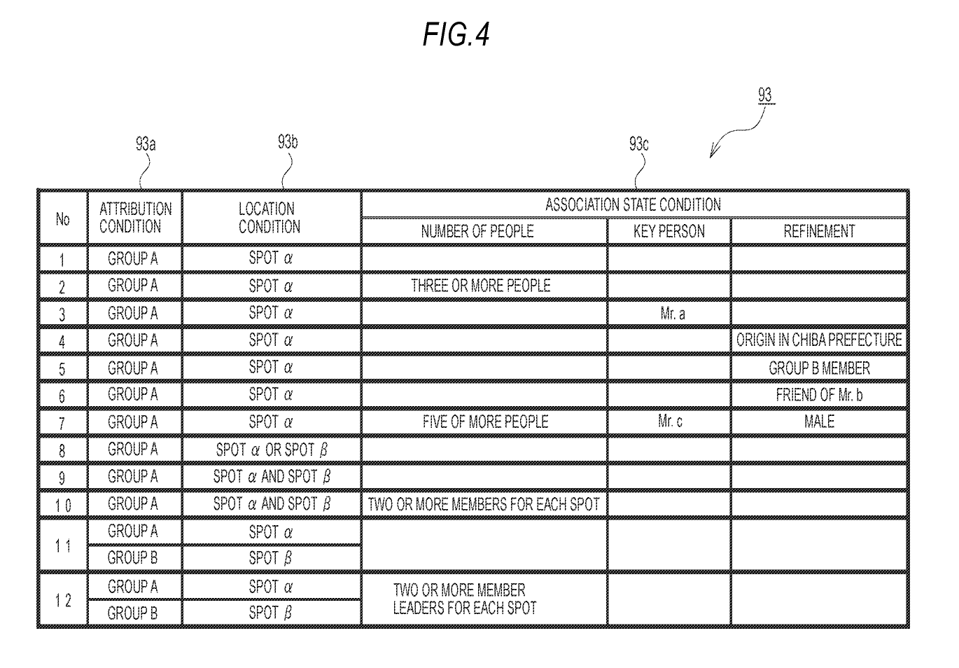

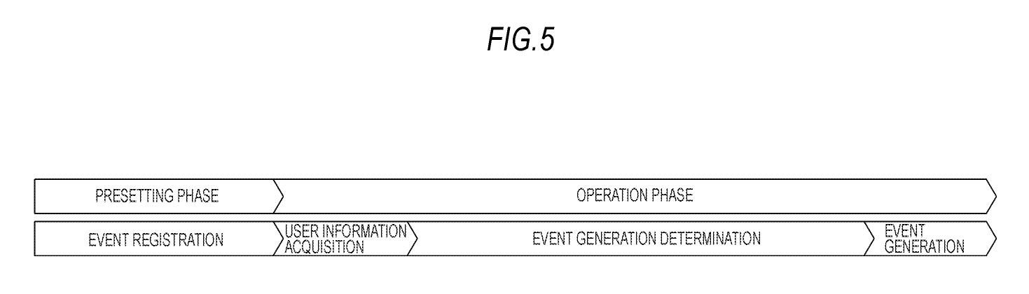

FIG. 4 illustrates the configuration of the event generation condition 93 that is used in the present embodiment. The attribution condition 93a, the location condition 93b, and the association state condition 93c are set in the event generation condition 93 shown in FIG. 4. In addition, the time condition 93d and the authentication condition 93e may be also set in the event generation condition 93.

The attribution condition 93a as referred to herein is a condition for determining the attribution of a user who wishes to generate an event or the user terminal 5. For example a SNS 3 participation state of the user is determined. More specifically, the participation state such as a group community on the SNS 3 to which the user belongs, or a status such as a hobby or taste stated by the user in the profile on the SNS 3 is determined. Examples of the group referred to herein include a company in which the user works, a department in the company, a circle to which the user belongs, and a school in which the user has been enrolled or from which the user has graduated, and examples of the status include the place of origin, the place of residence, the school in which the user has been enrolled or from which the user has graduated, the place of employment, and hobbies.

The location condition 93b is a condition that determines a location in which the event is wished to be generated. This condition can be set in group units of individual units. The location condition 93b may be set, for example, by designating the range of latitude and longitude, or may be set by designating an area that has been mapped on a map. When the location condition 93b is set by designating the range of latitude and longitude, the location condition can be set by designating a circular range by using the latitude and longitude of a central point and the distance from the central point. The method for setting the location condition 93b can be selected as appropriate according to the embodiment and is not limited to the method explained in the present disclosure. A plurality of spots or a position other than the fixed position may be set as the location condition 93b.

The association state condition 93c is a condition for determining the association state 8c of the user terminal 5 where an event is wished to be generated. For example, the number of users that satisfy the location condition 93b (“the number of users satisfying the location condition is equal to or greater than n”), the presence of a special user who should satisfy the location condition 93b (key person), and a refinement condition that the users should further satisfy may be set as the association state condition.

The time condition 93d is a condition for determining whether or not the present time 8d is a time at which the event is generated. For example, special month, date, day, and period can be set as the time condition.

The authentication condition 93e is used when the user of the user terminal 5 is wished to be authenticated. This condition is mainly used for enhancing security and identifying the user or key person. Specific methods used for authentication include the authentication using a typical user identifier (staff member number) and a password and also the voice authentication performed by inputting a test word, a password, and a staff member number by voice, the text authentication performed by writing a test word, a password, and a staff member number, the gesture authentication performed by detecting the user's pose or movement with an input device, the image and form authentication performed by capturing and analyzing the image of a membership card, a QR code, a barcode, and a background, the biometric authentication based on speaker authentication using a voice input, face authentication, fingerprints, palm authentication, iris-retina pattern authentication, vein pattern and handwriting, mnemonic authentication, and the like.

The event generation trigger transmission unit 25 transmits an event generation trigger to the user terminal 5 that satisfies the event generation condition 93, thereby allowing or instructing the generation of the event indicated in the event contents 91. Thus, the event generation trigger transmission unit 25 allows or instructs the generation of the event when the event generation condition 93 is satisfied.

The event contents storage destination information transmission unit 26 transmits the event contents storage destination information 92 to the user terminal 5 that satisfies the event generation condition 93.

### <Processing Flow>

The processing according to the present embodiment will be explained below with reference to FIG. 5 to FIG. 17. The specific contents and order of the processing explained in the present embodiment are implementation examples. The specific processing contents and order may be selected as appropriate according to the embodiment.

FIG. 5 illustrates the phases of processing in the system according to the present embodiment. The processing executed by the system according to the present embodiment is generally divided into a presetting phase and an operation phase. The presetting phase is constituted by the generation of the event information 9 and the registration of the event information 9. This phase corresponds to the so-called preliminary stage in which the event information 9 is generated in the event registration terminal 4 and the generated event information 9 is registered in the event control module 1 and the storage 2. The operation phase is constituted by the acquisition of the user information 8, the determination as to whether event generation is required, and the generation of the event. In this phase, the system is operated on the basis of the conditions that have been set in the presetting phase.

Initially, the processing performed in the presetting phase will be explained.

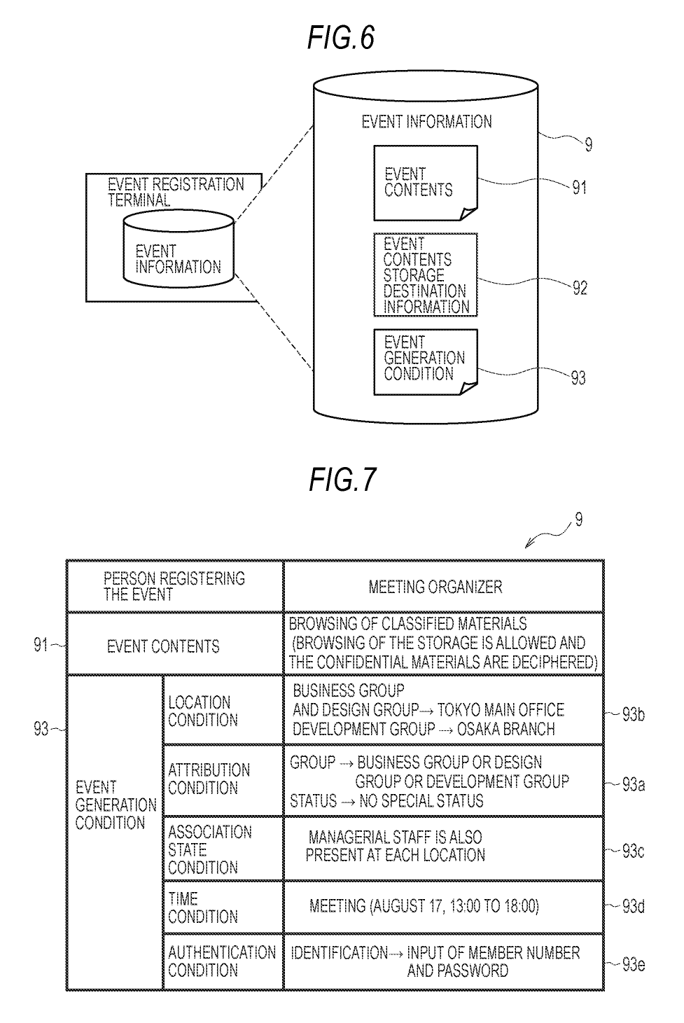

FIG. 6 illustrates schematically the event generation processing according to the present embodiment. The user who is an administrator inputs the event contents 91, the event generation condition 93, and the event contents storage destination information 92 into the event registration terminal 4. The event generation unit 41 of the event registration terminal 4 that has received the input generates the event information 9 including the event contents 91, the event generation condition 93, and the event contents storage destination information 92 according to the user's input.

FIG. 7 illustrates an example of the event information 9 generated in the present embodiment. In this example, the administrator creating the event information 9 is a meeting organizer who supposedly wishes to share the information on confidential materials with meeting participants only at the meeting, without distributing the materials by mail in advance and without disseminating the printed matter in order to prevent the leak of information. The materials to be browsed at the meeting are assumed to require the approval of the managerial staff of the department.

In order to create the event information 9 that will satisfy the above-described requirement, the administrator inputs into the event registration terminal 4: “browsing of classified materials (browsing of the storage 2 storing the confidential materials is allowed and the confidential materials are deciphered)” as the event contents 91, “Tokyo main office (business group and design group)” and “Osaka branch (development group)” as the location condition 93b among the event generation conditions 93, “business group or design group or development group” as the attribution condition 93a among the event generation conditions 93, “managerial staff of the users is also present at each location” as the association state condition 93c, “time period of the meeting (August 17, 13:00 to 18:00)” as the time condition 93d, and “input of staff member number and password” as the authentication condition 93e. In the event contents storage destination information 92, the storage 2 that can be browsed from the meeting area is set as appropriate, for example, as the “ΔΔ folder of ◯◯”. The event generation unit 41 of the event registration terminal 4 that has received the input generates the event information 9 including the event contents 91, the event generation condition 93, and the event contents storage destination information 92 according to the abovementioned inputted contents (see FIG. 7). Where the generation of the event information 9 is completed, the processing then advances to the event registration processing.

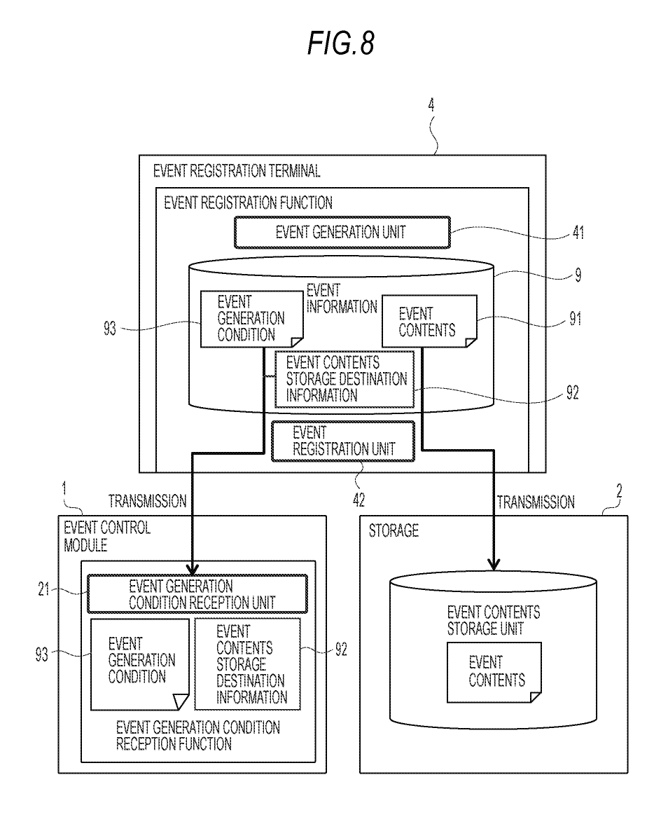

FIG. 8 illustrates schematically the event registration processing according to the present embodiment. Where the event information 9 is generated, the event registration unit 42 of the event registration terminal 4 registers the generated event information 9. More specifically, the event registration unit 42 of the event registration terminal 4 transmits the event generation condition 93 and the event contents storage destination information 92 to the event control module 1 and transmits the event contents 91 to the storage 2 indicated in the event contents storage destination information 92. The event generation condition reception unit 21 of the event control module 1 that has received the event generation condition 93 and the event contents storage destination information 92 registers the event generation condition 93 and the event contents storage destination information 92 in the auxiliary storage device 19. The storage 2 that has received the event contents 91 stores the event contents 91.

The processing in the operation phase will be explained below.

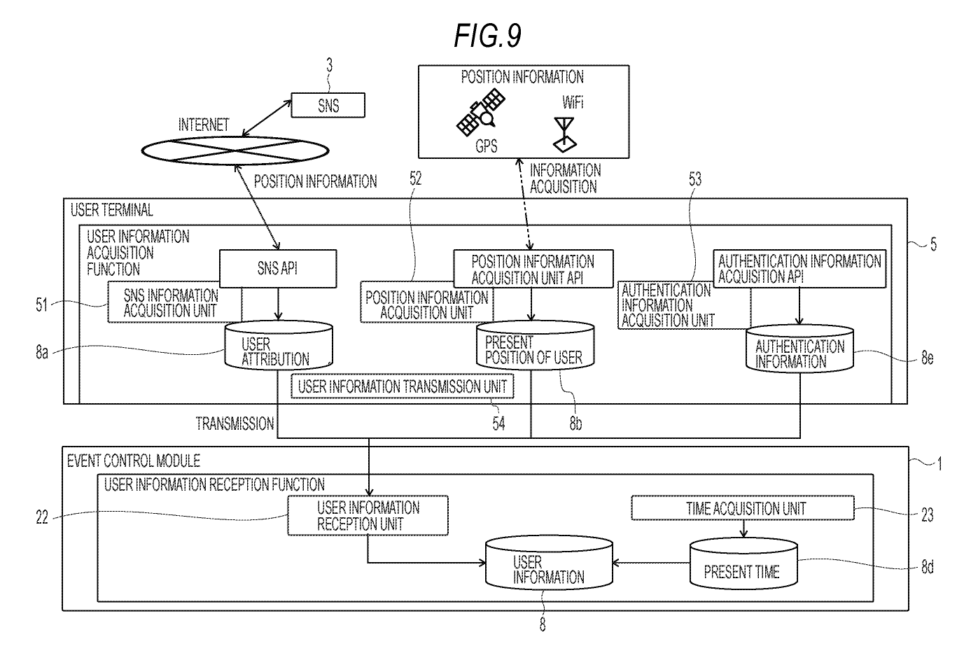

FIG. 9 illustrates schematically the user information acquisition processing according to the present embodiment. The processing illustrated by FIG. 9 is executed periodically when the event information 9 is registered. The user terminal 5 acquires the user information 8 and transmits the acquired information to the event control module 1. The user information 8 includes the user attribution 8a, the position information 8b and the authentication information 8e.

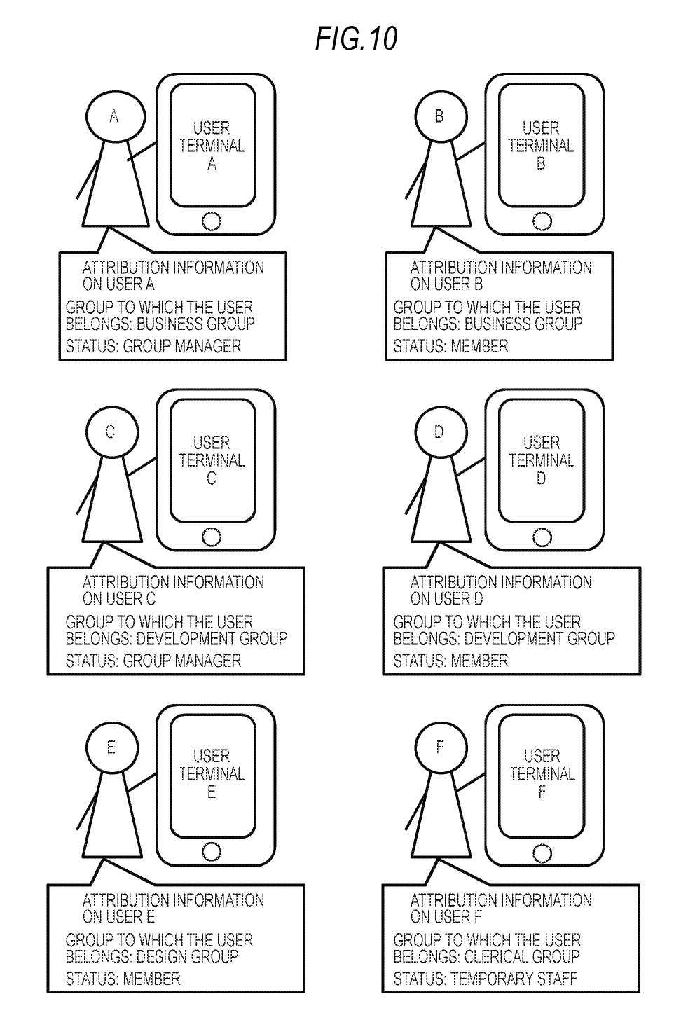

FIG. 10 illustrates an example of user attribution 8a that is acquired by the SNS information acquisition unit 51 of the user terminal 5 in the present embodiment. In the example shown in FIG. 10, the SNS information acquisition unit 51 of the user terminal 5 acquires the group to which the users belong in the company and the users' status (appointment or the like) as the user attribution 8a of users A to F from the API (Application Program Interface) of the SNS 3.

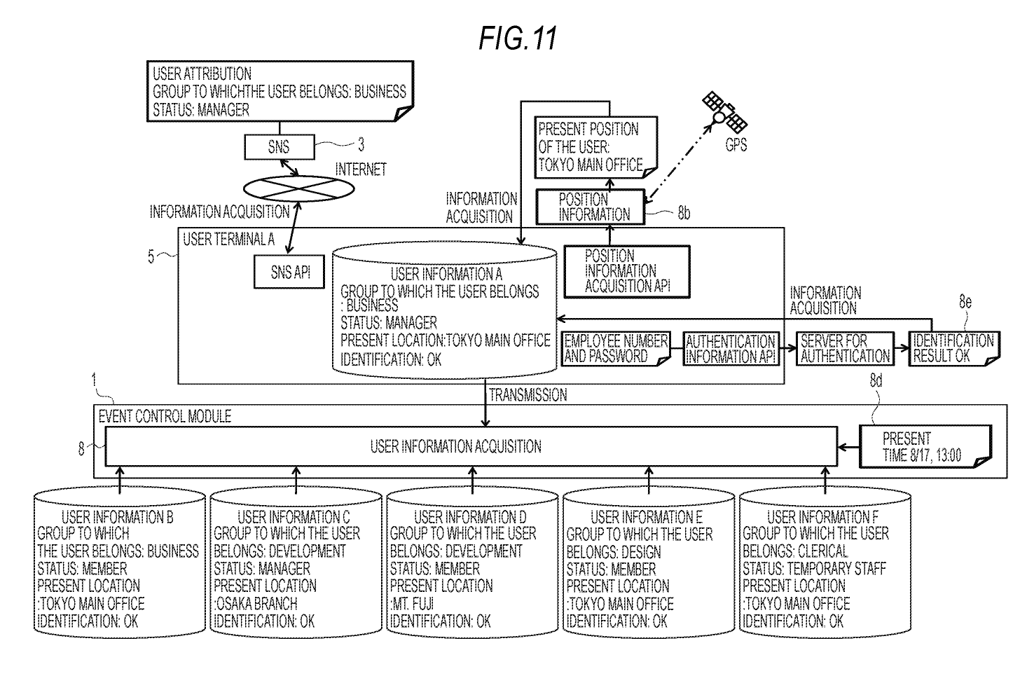

FIG. 11 illustrates by way of example a mode in which the user information 8 is acquired by a plurality of user terminals 5 and transmitted to the event control module 1 in the present embodiment. The SNS acquisition unit 51 of the user terminal 5 acquires the user attribution 8a via the Internet by a method of invoking the API of the SNS 3, and the position information acquisition unit 52 acquires the position information 8b of the user terminal 5 obtained by using GPS or the like via the API for position information acquisition. Further, the authentication information acquisition unit 53 of the user terminal 5 transmits, via the authentication information API or the like, to the authentication server a combination of the staff member number (employee number) and password inputted by the user. The authentication server that has received the combination of the staff member number and password determines whether or not this combination of the staff member number and password matches the staff member number and password of the user of the user terminal 5 that is the determination object. The combination of the staff member number and password of each user is stored in advance in the authentication server. Where the authentication (identification) of the users is completed, the authentication server transmits the authentication information 8e as the identification result to the user terminal 5.

Where the user information 8 such as the user attribution 8a, the position information 8b, and the authentication information 8e is acquired, the user information transmission unit 54 of the user terminal 5 transmits the acquired user information 8 to the event control module 1. The user information reception unit 22 of the event control module 1 receives the user information 8 transmitted from the user terminal 5. The time acquisition unit 23 of the event control module 1 acquires the present time 8d and incorporates the acquired time as the time acquired by the user information 8 in the user information 8.

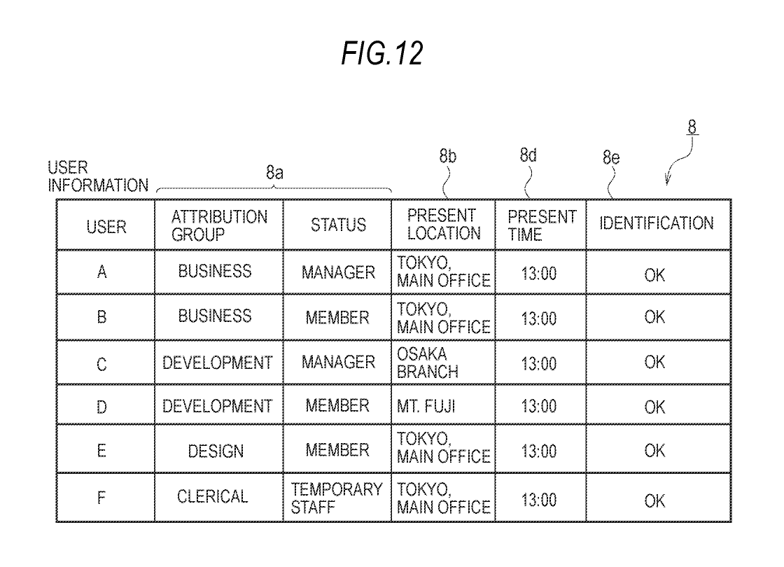

FIG. 12 illustrates an example of the user information 8 acquired by the event control module 1 in the present embodiment. Where the user information 8 is acquired, the processing advances to the event generation determination processing.

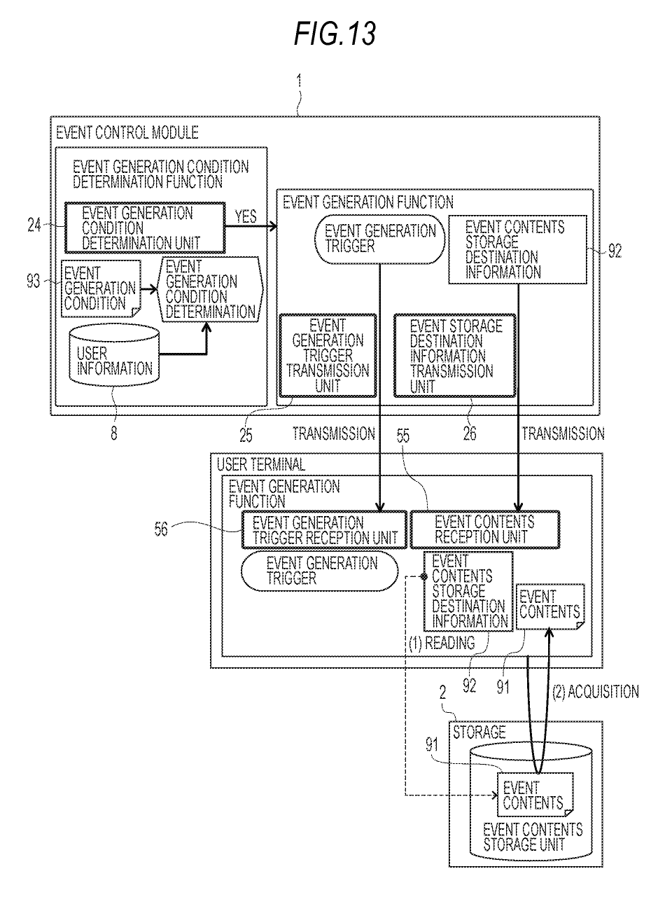

FIG. 13 illustrates schematically the event generation determination processing according to the present embodiment. In the event generation determination processing, the determination of the user information 8 and the event generation condition 93 is performed, and the event generation trigger and the event contents storage destination information 92 are transmitted to the user terminal 5 that satisfies the condition. The event generation determination processing will be described below in greater detail.

The event generation condition determination unit 24 reads from the auxiliary storage device 19 the event generation condition 93 that has been registered in advance in the event registration processing of the presetting phase and performs the event generation condition determination by comparing the read-out event generation condition with the user information 8 acquired in the user information acquisition processing.

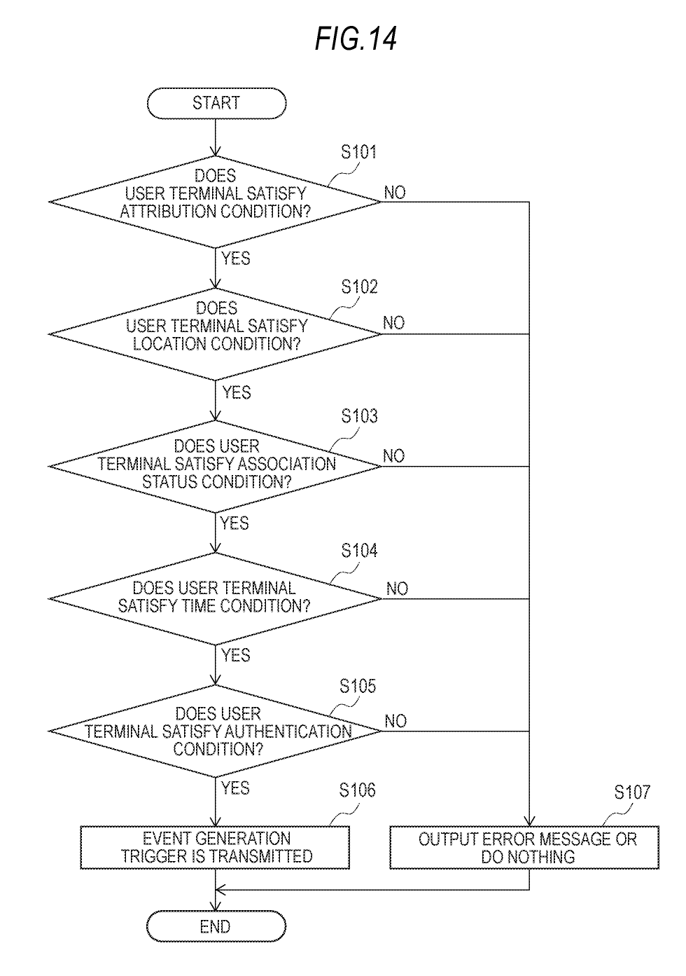

FIG. 14 is a flowchart illustrating the event generation condition determination processing according to the present disclosure. The processing indicated in the present flowchart is executed when the user information 8 is acquired by the user information reception unit 22.

In step S101, it is determined whether or not the attribution of the user using the user terminal 5 satisfies the attribution condition 93a. The event generation condition determination unit 24 determines whether or not the user attribution 8a included in the acquired user information 8 satisfies the attribution condition 93a that has been set in the event generation condition 93. Thus, in step S101, it is determined whether or not the user using the user terminal has the predetermined attribution.

In the example of event information 9 shown in FIG. 7, “business group or design group or development group” is set as the attribution condition 93a. Therefore, the event generation condition determination unit 24 determines whether or not the user attribution 8a corresponds to at least one of the business group, design group, and development group. In the example shown in FIG. 12, the users A to E satisfy the attribution condition 93a, but the user F belongs to a clerical group and does not satisfy the attribution condition 93a.

When the user attribution is determined not to satisfy the attribution condition 93a, the processing advances to step S107. Meanwhile, when the user attribution is determined to satisfy the attribution condition 93a, the processing advances to step S102.

In step S102, it is determined whether the present position of the user terminal 5 satisfies the location condition 93b. The event generation condition determination unit 24 determines whether or not the present position indicated by the position information 8b included in the acquired user information 8 satisfies the location condition 93b that has been set in the event generation condition 93. For example, when the position information 8b is indicated by latitude and longitude, the event generation condition determination unit 24 determines whether or not the latitude and longitude indicated by the position information 8b are within the ranges of latitude and longitude indicated in the location condition 93b, thereby determining whether or not the present position indicated by the position information 8b included in the user information 8 satisfies the location condition 93b.

In the example of the event information 9 shown in FIG. 7, “Tokyo main office (business group and design group)” and “Osaka branch (development group)” are set as the location condition 93b. Therefore, the event generation condition determination unit 24 determines whether or not the present position indicated by the position information 8b is within the range of the Tokyo main office with respect to the users belonging to the business group and design group (users A, B, and E in the example shown in FIG. 12) and determines whether or not the present position indicated by the position information 8b is within the range of the Osaka branch with respect to the users belonging to the development group (users C and D in the example shown in FIG. 12). In the example shown in FIG. 12, the users A to C, E, and F satisfy the location condition 93b, but the position information 8b on the user D indicates that the present location of the user D is Mt. Fuji, and the location condition 93b is not satisfied.

When the position information 8b of the user terminal 5 is determined not to satisfy the location condition 93b, the processing advances to step S107. Meanwhile, when the position information 8b of the user terminal 5 is determined to satisfy the location condition 93b, the processing advances to step S103.

In step S103, it is determined whether or not the state of association of the user terminal 5 satisfies the association state condition 93c. The event generation condition determination unit 24 determines whether or not the state of association (association state) of the predetermined user terminals 5 including the other user terminal 5 satisfies the association state condition 93c that has been set in the event generation condition 93. For example, the number of users satisfying the location condition 93b (“the number of users satisfying the location condition is equal to or greater than n”), the presence of a special user who satisfies the location condition 93b (key person is in the predetermined location), and a refinement condition that the users should further satisfy may be determined as the association state condition 93c.

As for the information on the association state 8c to be used in the determination using the association state condition 93c, the association condition can be acquired by referring to the association of user information including the user information 8 on the other user terminal 5 that has been accumulated by the event control module 1 and is shown in FIG. 12 and performing analytical processing corresponding to the association state condition. For example, when the association state condition 93c is “the number of users satisfying the location condition is equal to or greater than n”, the event generation determination unit 24 can acquire the association state by referring to the association of user information including the user information 8 on the other user terminal 5 that has satisfied the attribution condition and counting the number of users satisfying the location condition. Further, for example, when the association state condition 93c is “the special user satisfies the location condition 93b”, the event generation condition determination unit 24 can acquire the association state by referring to the association of user information including the user information 8 on the other user terminal 5 and determining whether or not the special user satisfies the location condition 93b.

In the example of event information 9 shown in FIG. 7, the condition of “managerial staff of the users is also present at each location” is set as the association state condition 93c. Therefore, the event generation condition determination unit 24 determines whether or not the user representing a managerial staff is present in the range of the Tokyo main office with respect to the users belonging to the business group and design group (the users A, B, and E in the example shown in FIG. 12) and determines whether or not the user representing a managerial staff is present in the range of the Osaka branch with respect to the users belonging to the development group (the users C and D in the example shown in FIG. 12). In the example shown in FIG. 12, the user A representing the managerial staff (manager) of the business group is in the Tokyo main office and therefore the association state condition 93c is satisfied with respect to the users A and B, and the user C representing the managerial staff (manager) of the development group is in the Osaka branch and therefore the association state condition 93c is satisfied with respect to the users C and D, but the managerial staff of the design group is not present and therefore the association state condition 93c is not satisfied with respect to the user E.

When the state of association of the user terminal 5 is determined not to satisfy the association state condition 93c, the processing advances to step S107. Meanwhile, when the state of association of the user terminal 5 is determined to satisfy the association state condition 93c, the processing advances to step S104.

In step S104, it is determined whether or not the present time 8d satisfies the time condition 93d. The event generation determination unit 24 determines whether or not the present time 8d included in the acquired user information 8 satisfies the time condition 93d that has been set in the event generation condition 93. More specifically, the event generation condition determination unit 24 determines whether or not the present time 8d is after the start time and before the end time indicated in the time condition 93d, thereby determining whether or not the present time 8d satisfies the time condition 93d. However, only either of the start time and end time may be set as the time condition 93d.

In the example of event information 9 indicated in FIG. 7, the condition of “time period of the meeting (August 17, 13:00 to 18:00)” is set as the time condition 93d. Therefore, the event generation condition determination unit 24 determines whether or not the present time 8d is after 13:00 and before 18:00 on August 17. In the example shown in FIG. 12, the event generation condition determination processing is executed in the time period of the meeting, and all of the users A to F satisfy the time condition 93d.

When the present time 8d is determined not to satisfy the time condition 93d, the processing advances to step S107. Meanwhile, when the present time 8d is determined to satisfy the time condition 93d, the processing advances to step S105.

In step S105, it is determined whether or not the authentication information 8e on the user terminal 5 satisfies the authentication condition 93e. The event generation condition determination unit 24 determines whether or not the authentication information 8e included in the acquired user information 8 satisfies the authentication condition 93e that has been set in the event generation condition 93.

In the example of event information 9 shown in FIG. 7, the condition of “input of staff member number and password” is set as the authentication condition 93e. Therefore, the event generation condition determination unit 24 performs the determination by referring to whether or not the authentication information 8e indicating that the staff member number and password have been inputted and the identification with the authentication server has been performed is included in the user information 8. In the example shown in FIG. 12, all of the users A to F satisfy the authentication condition 93e. In the present embodiment, the identification result obtained with the authentication server is included as the authentication information 8e into the user information 8 and the determination is performed with reference to this identification result, but instead of using such a method, it is also possible to determine whether or not the authentication condition 93e is satisfied by including the staff member number and password into the user information 8 and determining the validity of the staff member number and password with the event control module 1.

When the authentication information 8e is determined not to satisfy the authentication condition 93e, the processing advances to step S107. Meanwhile, when the authentication information 8e is determined to satisfy the authentication condition 93e, the processing advances to step S106.

In step S106, the event generation trigger is transmitted. The event generation trigger transmission unit 25 determines that the event generation condition 93 is satisfied and sends the event generation trigger to the user terminal 5 when all of the conditions have been determined in steps S101 to S105 to be satisfied.

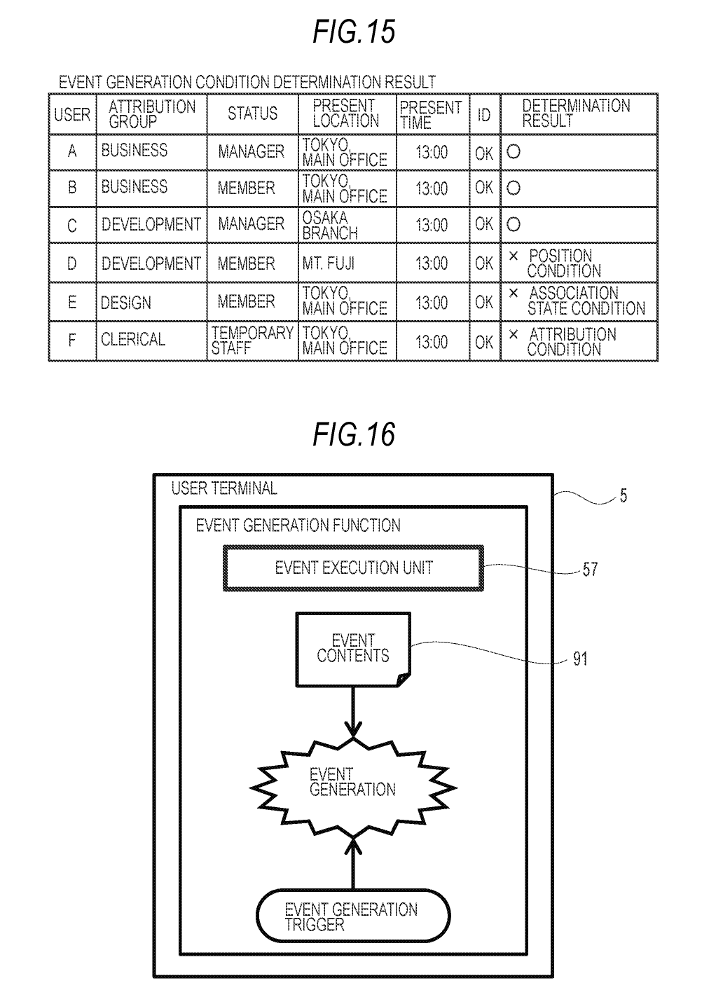

FIG. 15 illustrates an example of the event generation condition determination result according to the present embodiment. In the example shown in FIG. 15, the event generation condition 93 is satisfied with respect to the users A to C and therefore the event generation trigger is transmitted by the event generation trigger transmission unit 25. Meanwhile, the event generation condition 93 is not satisfied with respect to the users D to F and therefore the event generation trigger is not transmitted. The processing illustrated by the present flowchart is thereafter ended and the processing advances to the event generation processing.

In step S107, an error message is outputted. When a condition has not been satisfied in any of the determinations of steps S101 to S105, the event control module 1 determines that the event generation condition 93 is not satisfied and transmits an error message to the user terminal 5. In the example shown in FIG. 15, the event generation condition 93 is not satisfied with respect to the users D to F and therefore an error message is transmitted thereto. The processing illustrated by the present flowchart is thereafter ended.

It is also possible not to transmit the error message in step S107. For example, it is possible not to transmit an error message with respect to an event for which the output of the error message is undesirable, such as an event for which the event generation condition determination processing is executed periodically and which is automatically generated at a point of time in which the event generation condition 93 is satisfied. Meanwhile, the error message may be transmitted with respect to an event for which it is preferred that the user be notified of the fact that the event is not generated, such as an event for which the event generation condition determination processing is performed upon the reception of a request for the event from the user.

The processing flow relating to the case in which the event generation condition 93 is determined to be satisfied in the event generation condition determination processing illustrated by the flowchart shown in FIG. 14 will be explained below by referring again to FIG. 13. As mentioned hereinabove (see step S106 in FIG. 14), when the event generation condition 93 is satisfied, the event generation trigger transmission unit 25 transmits an event generation trigger to the user terminal 5. The transmitted event generation trigger is received by the event generation trigger reception unit 56 of the user terminal 5.

Further, the event contents storage destination information transmission unit 26 of the event control module 1 reads the event contents storage destination information 92 corresponding to the satisfied event generation condition 93 from the auxiliary storage device 19 and transmits the event contents storage destination information to the user terminal 5. Upon receiving the event contents storage destination information 92, the event contents reception unit 55 of the user terminal 5 refers to the event contents storage destination information 92, accesses the storage 2 indicated in the event contents storage destination information 92, and acquires the event contents 91 corresponding to the satisfied event generation condition 93 from the storage 2. The processing thereafter advances to the event generation processing.

In the present embodiment, the event contents storage destination information 92 and the event contents 91 are acquired by the user terminal 5 when the event generation condition 93 is satisfied, but the event contents storage destination information 92 and the event contents 91 may be also acquired in advance (before the event generation condition 93 is satisfied) by the user terminal 5. In such a case, the event can be generated by only issuing an event generation trigger when the event generation condition 93 is satisfied.

FIG. 16 illustrates schematically the event generation processing according to the present embodiment. Where the event execution unit 57 of the user terminal 5 receives the event generation trigger by the event generation trigger reception unit 56, the event execution unit generates an event according to the event contents 91. As mentioned hereinabove, the event generation as referred to herein may be the execution of predetermined software for the event or the issuance of an instruction (command) corresponding to a predetermined function.

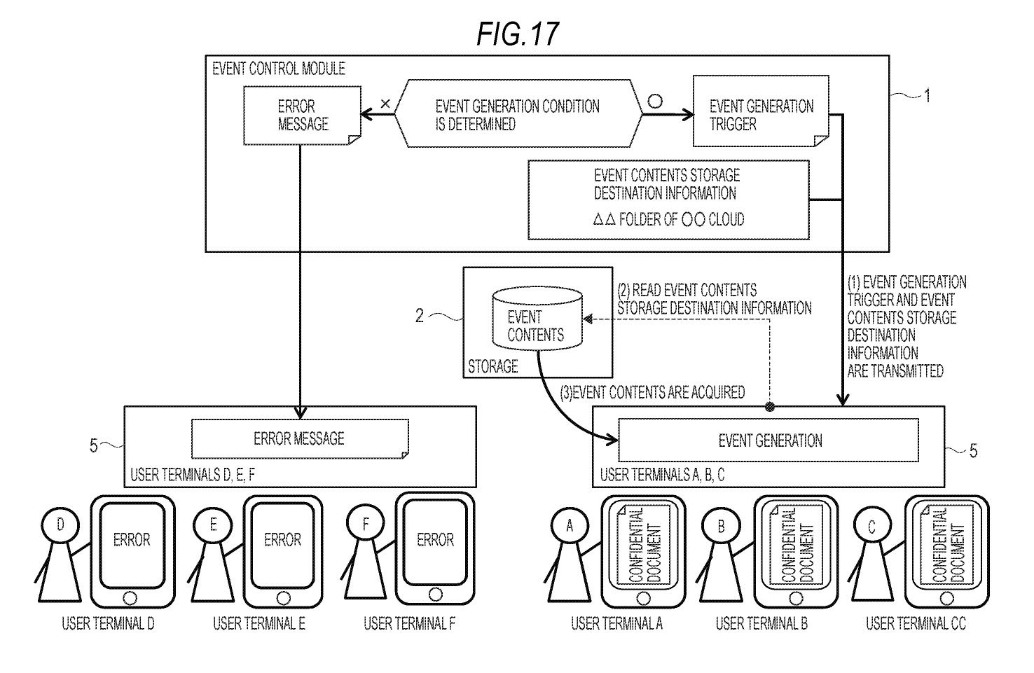

FIG. 17 illustrates an example of event generation mode for each user terminal 5 according to the present embodiment. In the example illustrated by FIG. 15, the users A, B, and C all satisfy the event generation condition 93. Therefore, the terminals thereof can receive the event generation trigger and the event contents storage destination information 92, acquire the “browsing of confidential document” of the event contents 91, and generate the event (see FIG. 17). By contrast, the user D does not satisfy the location condition 93b, the user E does not satisfy the association state condition, and the user F does not satisfy the attribution condition 93a. Therefore, those users cannot receive the event generation trigger and the event contents storage destination information 92 and cannot acquire the event contents 91 (see FIG. 17). Furthermore, even if the users D to F receive the event contents 91 at a later date, since the time condition 93d will not be satisfied, it will be impossible to receive the event generation trigger and the event contents storage destination information 92 or acquire the event contents 91.

Further, it is also possible to encode the event contents 91 and the event contents storage destination information 92, and the event generation may be allowed or instructed when the event generation trigger transmission unit 25 issues an event generation trigger as a decoding key for decoding the encoded event contents 91 and event contents storage destination information 92. In such case, even when the user terminal 5 attempts to generate an event in a state in which the event generation condition 93 is not satisfied, the event contents 91 and the event contents storage destination information 92 cannot be decoded. Thus, with such a mode, the user can be prevented from wrongly generating an event.

### <Variations>

The variation embodiments relating to the implementation of the system according to the present disclosure will be explained below.

In the above-described embodiment, an example is explained in which the event generation information 93 and the event contents storage destination information 92, from the types of information included in the event information 9, are registered from the event registration terminal 4 to the event control module 1, and the event contents 91 are directly stored from the event registration terminal 4 to the storage 2, but various registration routes of the event information 9 may be used.

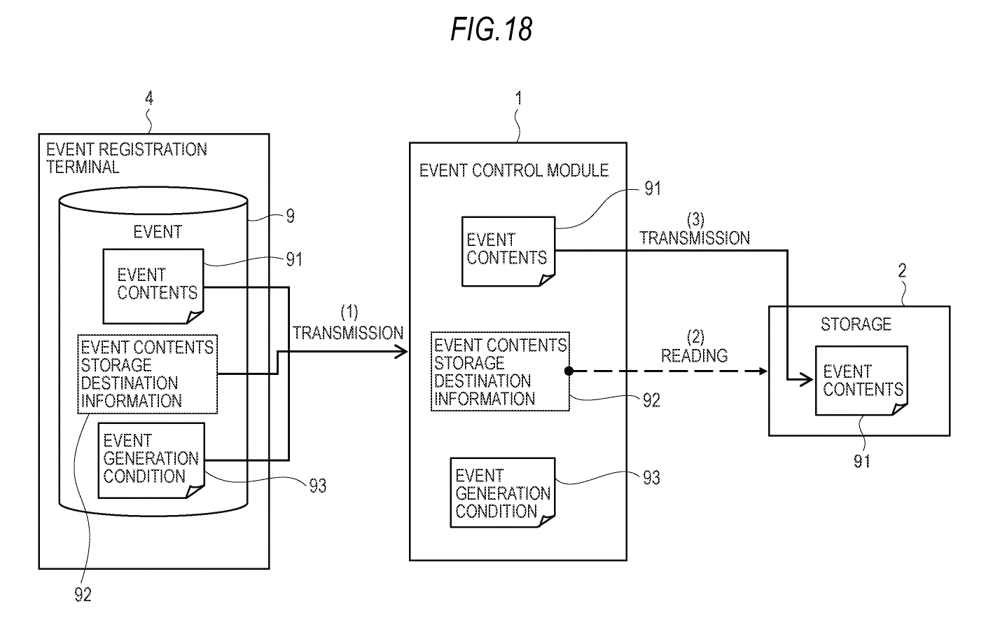

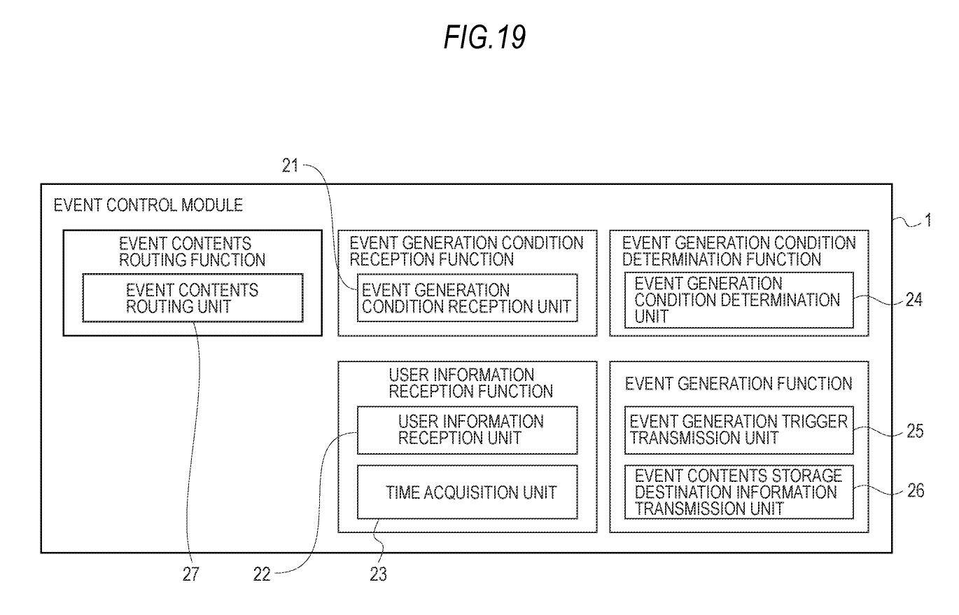

FIG. 18 illustrates a variation of event registration. FIG. 19 illustrates schematically the functional configuration of the event control module 1 in the variation shown in FIG. 18. In the example shown in FIG. 18, the event contents 91, the event generation information 93, and the event contents storage destination information 92 included in the event information 9 are transmitted from the event registration terminal 4 to the event control module 1. Then, the event control module 1 registers the event generation information 93 and the event contents storage destination information 92, from the received types of information, and transfers the event contents 91 to the storage 2 for storing the event contents in the storage 2. Therefore, the event control module 1 according to the present variation is provided with an event contents routing function implemented by an event contents routing unit 27, in addition to the functions described hereinabove with reference to FIG. 3C (see FIG. 19).

In the above-described embodiment, a mode in which the event generation trigger and the event contents storage destination information 92 are transmitted by the event control module 1 to the address of the user terminal 5, the user terminal 5 that has received the event generation trigger and the event contents storage destination information goes for the event contents 91 to the storage 2 with reference to the event contents storage destination information 92, and an event is generated in the user terminal 5 is used as a mode of event generation in the case where the event generation condition 93 is satisfied. However, other modes of event generation may be used instead of the aforementioned mode.

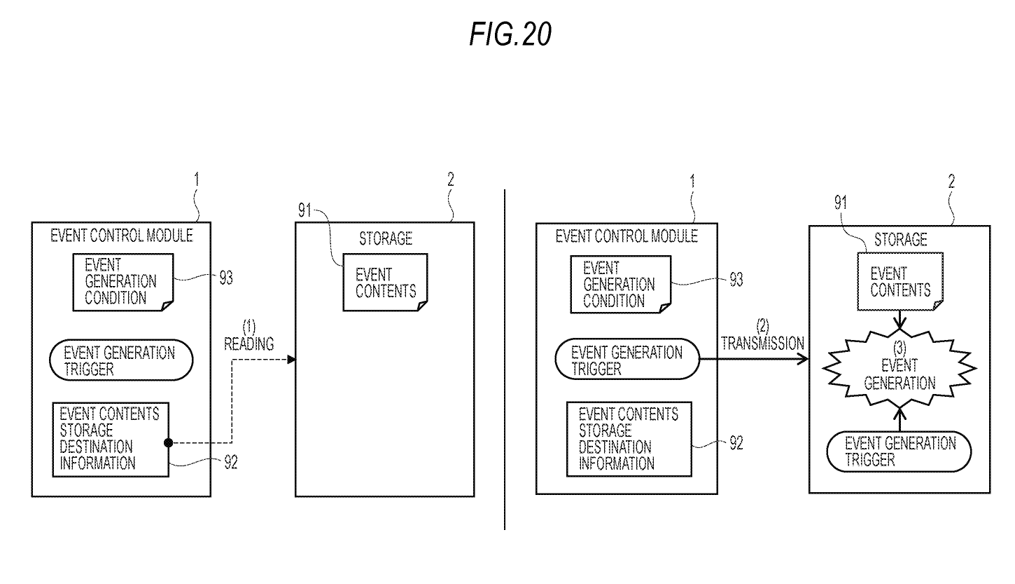

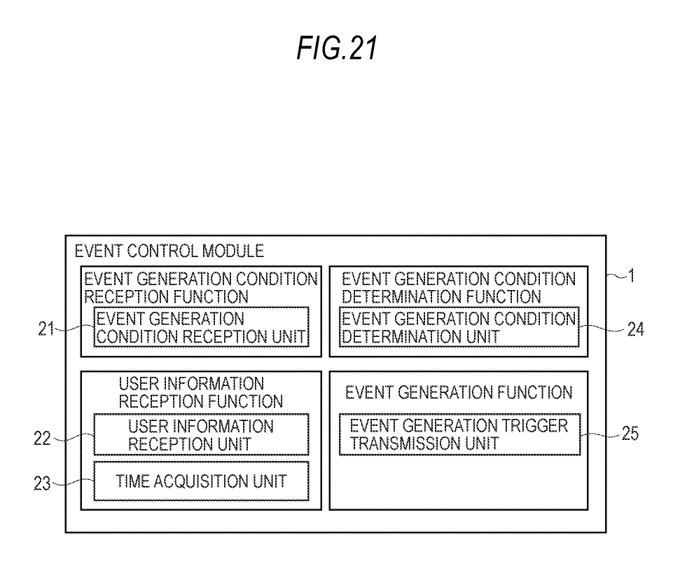

FIG. 20 illustrates a mode of event generation in the case where an event is generated in the storage 2. FIG. 21 illustrates schematically the functional configuration of the event control module 1 in the variation illustrated by FIG. 20. In the example illustrated by FIG. 20, where the event generation condition 93 is satisfied, the event control module 1 initially transmits an event generation trigger to the storage 2 with reference to the event contents storage destination information 92. Then, an event is generated by a set of the event generation trigger and the event contents 91 in the storage 2. Therefore, the event control module 1 according to the present variation may be configured without using the event contents destination storage information transmission unit 26 explained hereinabove with reference to FIG. 3C. Further, the event generation trigger transmission unit 25 of the event control module 1 transmits the event generation trigger to the storage 2 (see FIG. 21).

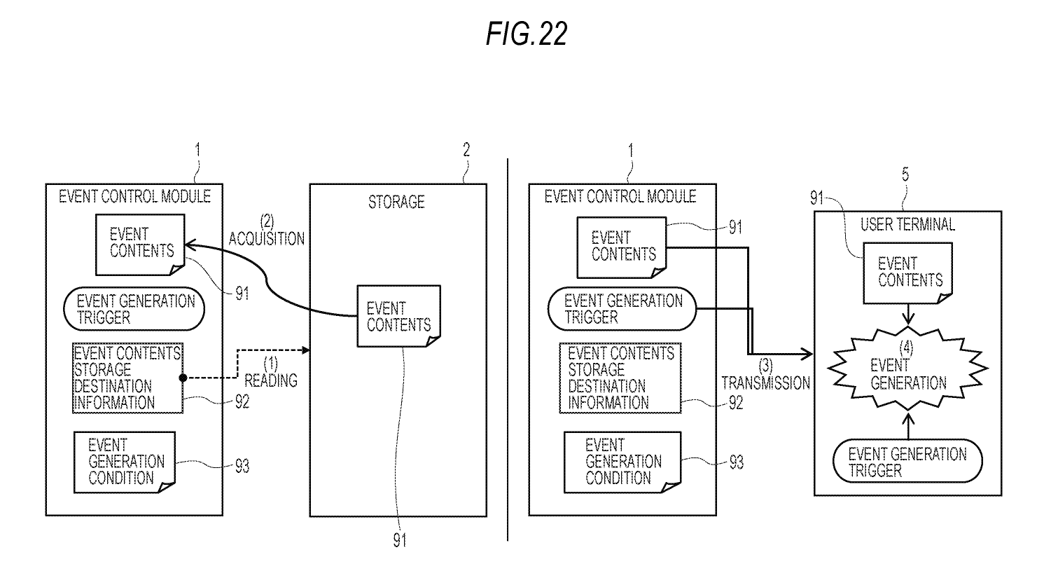

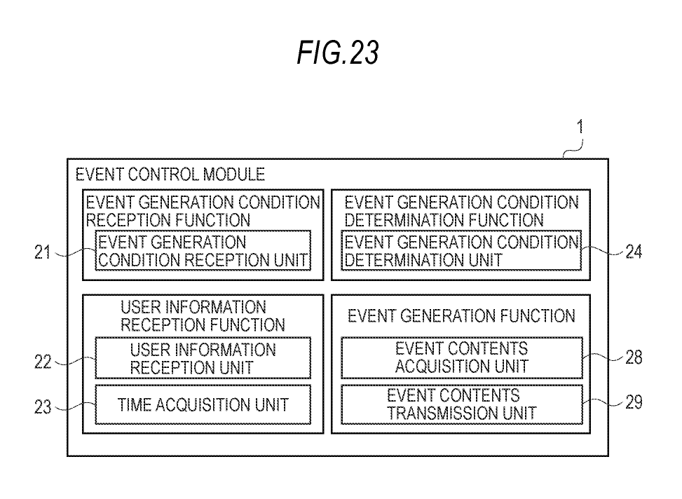

FIG. 22 illustrates a mode of event generation in the case where an event is generated in the user terminal 5. FIG. 23 illustrates schematically the functional configuration of the event control module 1 in the variation illustrated by FIG. 22. In the example illustrated by FIG. 22, where the event generation condition 93 is satisfied, the event control module 1 initially goes for the event contents 91 to the storage 2 with reference to the event contents storage destination information 92. Then, when the event control module 1 transmits the event contents 91 and the event generation trigger to the user terminal 5, the set of the event generation trigger and the event contents 91 is completed in the user terminal 5 and an event is generated. Accordingly, the event control module 1 according to the present variation is provided with an event contents acquisition unit 28 that acquires the event contents 91 from the storage 2 with reference to the event contents storage destination information 92 and an event contents transmission unit 29 that transmits the event contents 91 to the user terminal 5 instead of the event generation trigger transmission unit 25 and the event contents storage destination information transmission unit 26 explained hereinabove with reference to FIG. 3C (see FIG. 23).

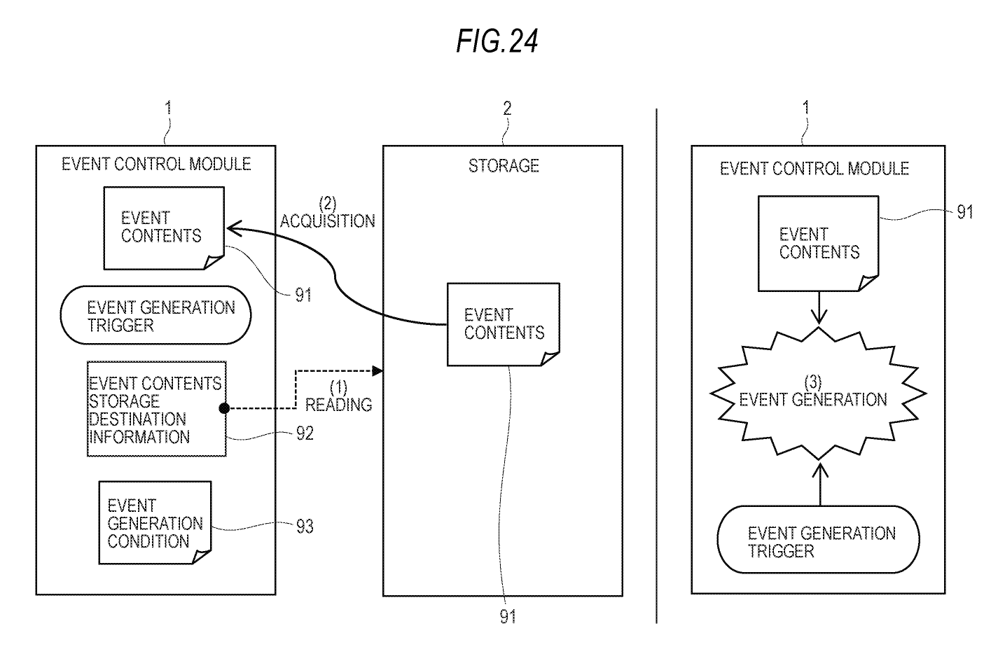

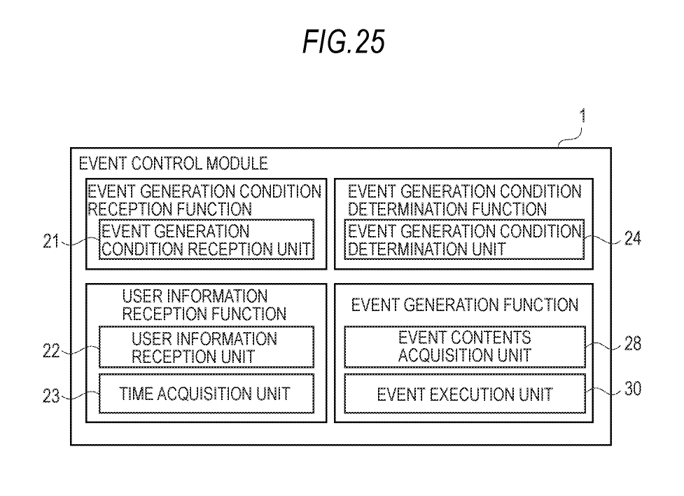

FIG. 24 illustrates a mode of event generation in the case where an event is generated in the event control module 1. FIG. 25 illustrates schematically the functional configuration of the event control module 1 in the variation illustrated by FIG. 24. In the example illustrated by FIG. 24, where the event generation condition 93 is satisfied, the event control module 1 initially goes for the event contents 91 to the storage 2 with reference to the event contents storage destination information 92. Then an event is generated by the set of the event generation trigger and the event contents 91 in the event control module 1. Therefore, the event control module 1 according to the present variation is provided with the event contents acquisition unit 28 that acquires the event contents 91 from the storage 2 with reference to the event contents storage destination information 92 and an event execution unit 30 that generates an event when the set of the event generation trigger and the event contents 91 is completed instead of the event generation trigger transmission unit 25 and the event contents storage destination information transmission unit 26 explained hereinabove with reference to FIG. 3C (see FIG. 25).

### <Application Examples of System>

Specific examples of systems to which the present disclosure can be applied are explained below.

### (Game System)

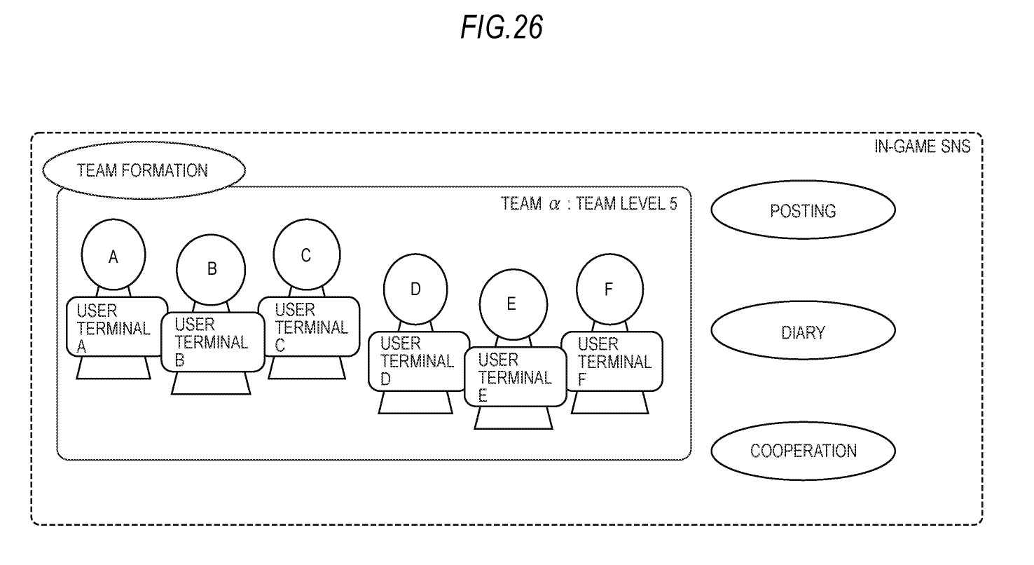

FIG. 26 illustrates an example in which the system according to the present embodiment is applied to a game system in which a plurality of users is connected to each other by a network by using user terminals 5 and play simultaneously. In the present embodiment the user terminals 5 have a game function in addition to the functions explained hereinabove. In the game, for example, a plurality of users combines the efforts to defeat a monster, and the object of the game is to procure the privileges or items that can be used in the game.

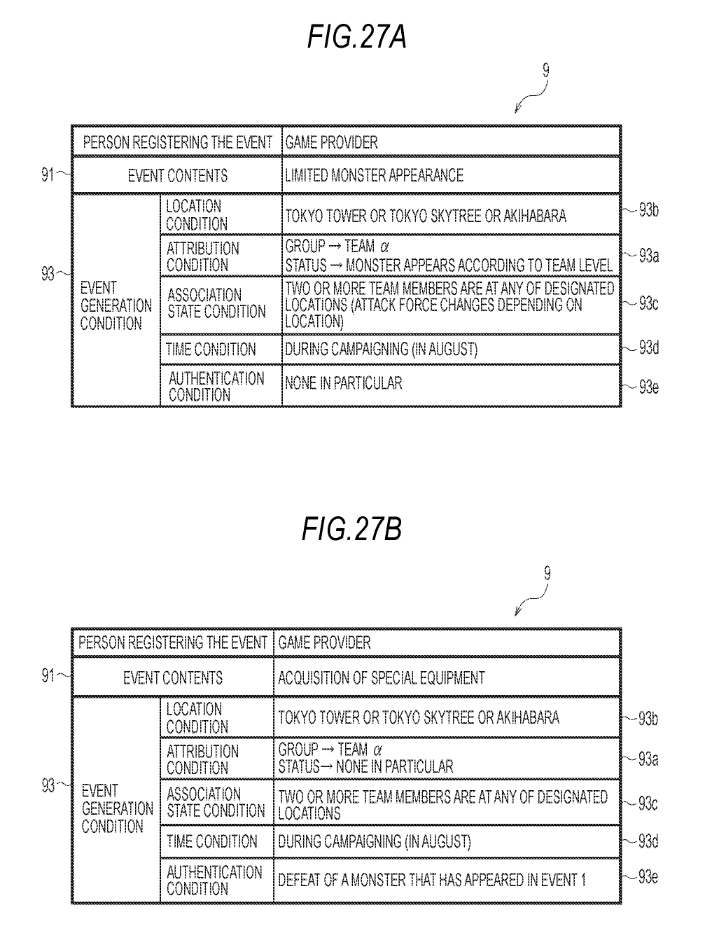

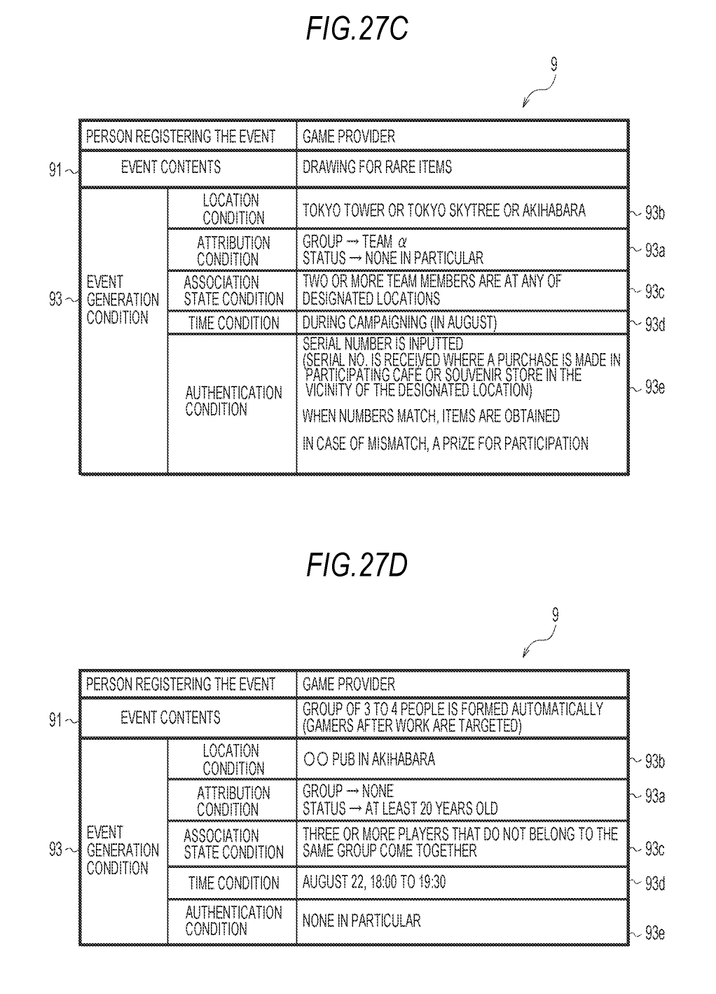

FIG. 27A to FIG. 27D illustrate examples of the event information 9 that is registered when the system according to the present embodiment is applied to a game system. In the examples illustrated by FIG. 27A to FIG. 27C, the team a shown in FIG. 26 can generate an event in the case where two or more members of the team are present in a Tokyo tower, a Tokyo Skytree, or Akihabara within a campaign period (August). The event generated herein is a limited monster appearance or a drawing for acquiring special equipment in the game or acquiring rare items in the game. According to the event information 9 illustrated by FIG. 27B, the defeat of a limited monster that has appeared in the event relating to the event information 9 illustrated by FIG. 27A is set as the authentication information 93e. The relevancy to a plurality of events may thus be maintained.

According to such an example, the game provider can increase the advertising effect due to a combination with the sightseeing location that has been set in the location condition 93b, and the sightseeing location that has been set in the location condition 93b can attract customers by using the game. Further, the user also can play the game, while interacting with other users, and can earn privileges.

Further, in the example illustrated by FIG. 27D, the condition of “three or more players (users) who do not belong to the same group get together” is set as the association state condition 93c, and the event contents 91 indicate “group of 3 to 4 people is formed automatically”. In such a case, the users who are not usually assembled in a team can get together, form a new team, and play a game. Thus, where such event information 9 is set, when the user reaches the meeting place (a shop collaborating with a game business establishment), a team is formed automatically and the game is played in a team. After the automatically assembled team ends the game, the team may be disassembled or maintained.

### (System Linked to Local Community)

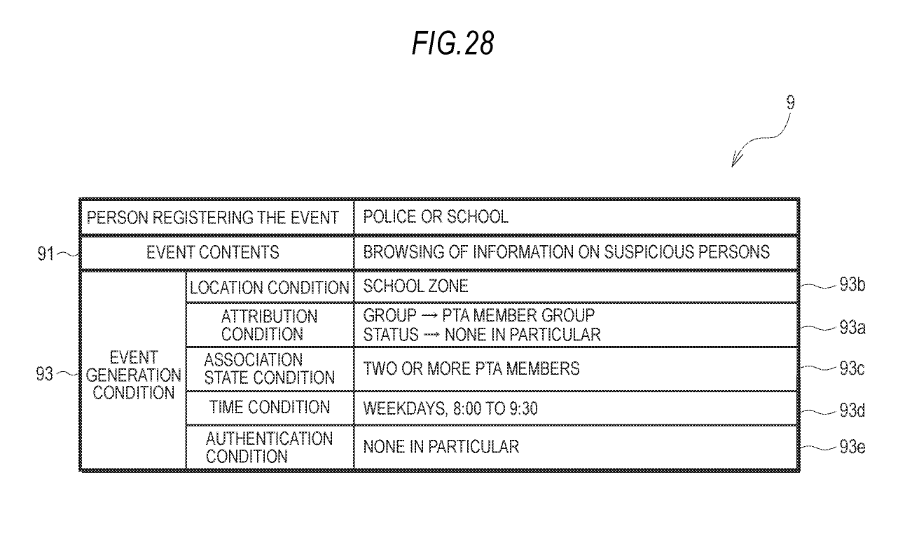

FIG. 28 illustrates an example of the event information 9 that is registered in the case where the system according to the present embodiment is applied to a system linked to a local community. In local communities such as schools, regions, and PTA, measures have been taken to prevent children from being involved in traffic accidents or crimes when commuting to school. More specifically, several adults stand at the bus stops of school buses and intersections and watch over the children. Such actions are taken in turns.

Further, information on suspicious individuals within a school zone is provided from police or schools, but such information should be handled carefully for personal information protection and safety of the persons involved. Since making and distributing multiple copies demand a lot of attention, only a limited number of copies are usually circulated, and the following problems are generally associated with such an approach. Thus, it is necessary to attend a meeting to see the copy, the time is limited and rapid browsing is impossible, necessary information is difficult to search since the information is printed on paper, and the newest information cannot be obtained.

Accordingly, the convenience of information browsing can be increased by setting the event information 9 such as shown in FIG. 28 and enabling browsing by using the user terminal 5 only when the event condition is satisfied.

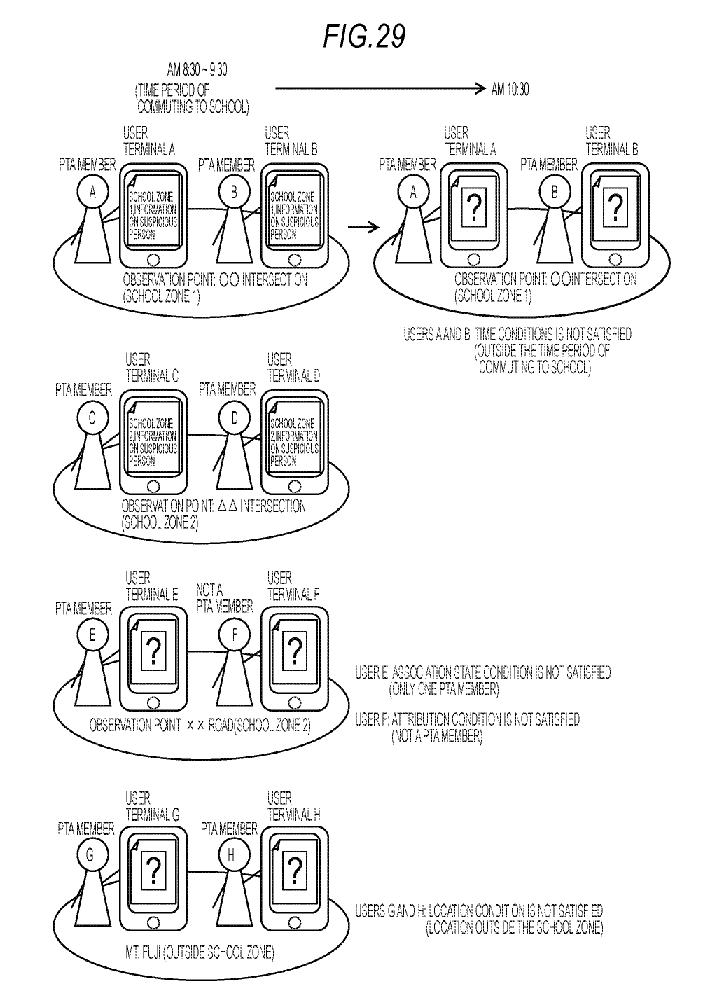

FIG. 29 illustrates an event generation status in the case where the system according to the present embodiment is operated by using the event information 9 shown in FIG. 28. When the users A and B stand together at the intersection in a school zone 1 within the time period of commuting to school on a weekday from 8:00 to 9:30, the event generation condition 93 indicated in the event information 9 is satisfied. Therefore, the users A and B can browse the information on suspicious individuals relating to the school zone 1. When the users C and D also stand together at the intersection in a school zone 2 within the time period of commuting to school on a weekday from 8:00 to 9:30, the event generation condition 93 indicated in the event information 9 is satisfied. Therefore, the users C and D can browse the information on suspicious individuals relating to the school zone 2. However, when the users A and B or the users C and D stand together at a predetermined intersection in a time period that is not the time period of commuting to school, the users cannot browse the information on suspicious individuals.

Further, even if the users E and F stand together at the intersection in a school zone 2 within the time period of commuting to school on a weekday from 8:00 to 9:30, since the user F does not satisfy the attribution condition 93a of “group→PTA member group” and the user E does not satisfy the association state condition 93c of “the number of PTA members is two or more”, the users E and F cannot browse the information on suspicious individuals. In addition, even if the users G and H are in the same place within the time period of commuting to school on a weekday from 8:00 to 9:30, since both of them do not satisfy the location condition 93b of “within a school zone”, the users G and H cannot browse the information on suspicious individuals.

### (Orienteering System)

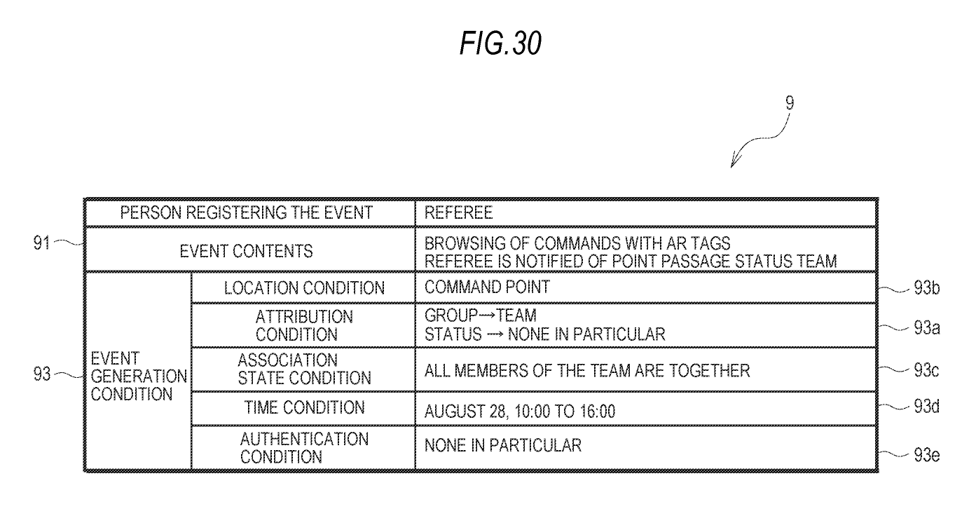

FIG. 30 illustrates an example of the event information 9 that is registered when the system according to the present embodiment is applied to an orienteering system. In the conventional orienteering team activities, even when a team cheats by using individual members, rather than the entire team, to pass the points and claiming that the goal is reached by the team, it is difficult for a referee to detect the fraud.

Accordingly, a referee can detect the fraud by setting the association state condition 93c of “all members of the team are together” and setting the event contents 91 to “referee is notified of point passage by team” in the event information 9 such as illustrated by FIG. 30.

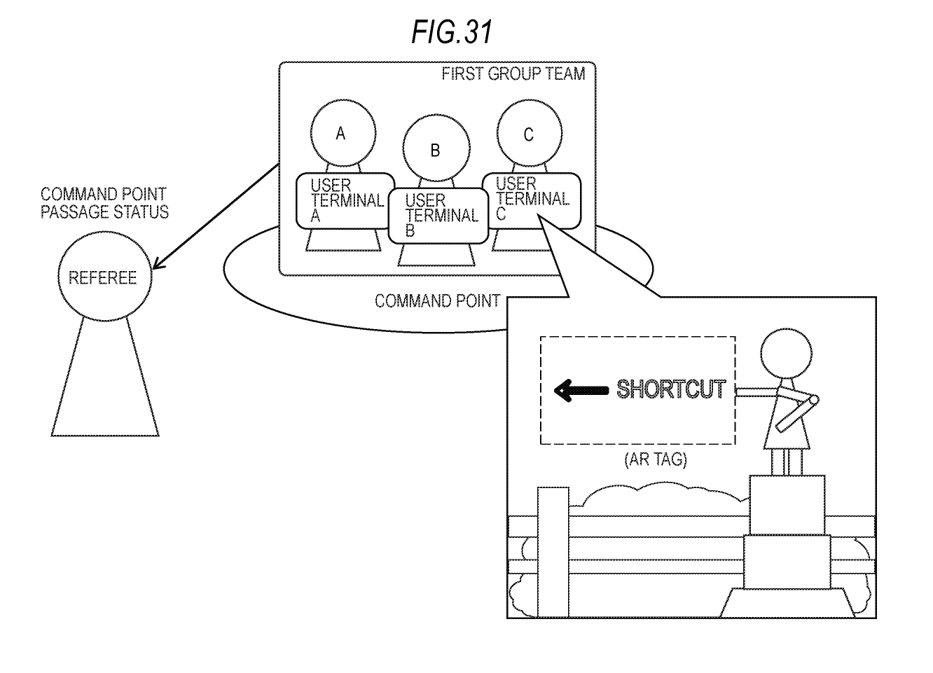

FIG. 31 illustrates the event generation status in the case where the system according to the present embodiment is operated by using the event information 9 shown in FIG. 30. Where a team passes a command point, the referee can receive the passage status with respect to the team including all of the team members.

By further setting “browsing of commands with AR (Augmented Reality) tags” as the event contents 91, it is possible to offer a privilege of all members of the team being together to the participants of orienteering. As shown in FIG. 31, an AR tag is an image displayed with superposition on an image picked up with the camera of the user terminal 5 and this image can provide the information necessary for proceeding in orienteering.

### (Meeting Management System)

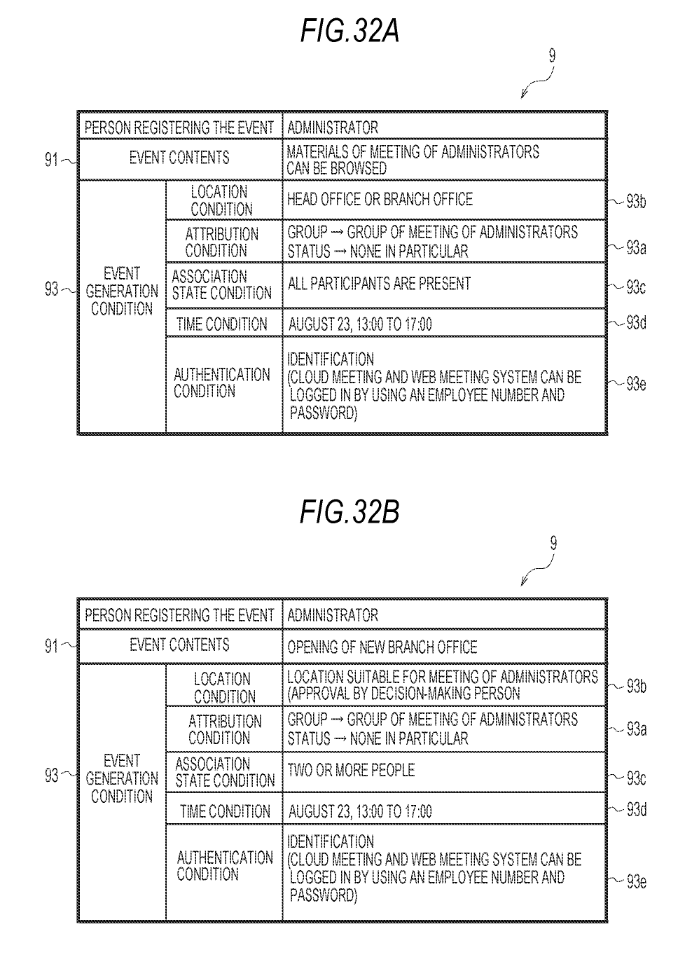

FIG. 32A and FIG. 32B illustrate an example of the event information 9 registered in the case where the system according to the present embodiment is applied to a meeting management system. When secret information is handled at the meeting, it is important to ensure the security of the documents browsed at the meeting.

According to the event generation condition 93 that has been set in the event information 9 illustrated by FIG. 32A, the documents cannot be browsed unless all of the identified participants have gathered at the location where the meeting is to take place. Among the “head office or branch office” of the location condition 93b shown in FIG. 32A, the “branch office” can be added by generating a “new branch is opened” event relating to the event information 9 shown in FIG. 32B. Thus, according to the present example, even if all of the members have not gathered together in the branch office that has been set in advance, where two or more identified users that belong to the executive committee group are present in the location where a new branch office is wished to be opened, this location can be newly set as a branch office, the event shown in FIG. 32A can be generated and the documents can be browsed.

### (Shared Notebook System)

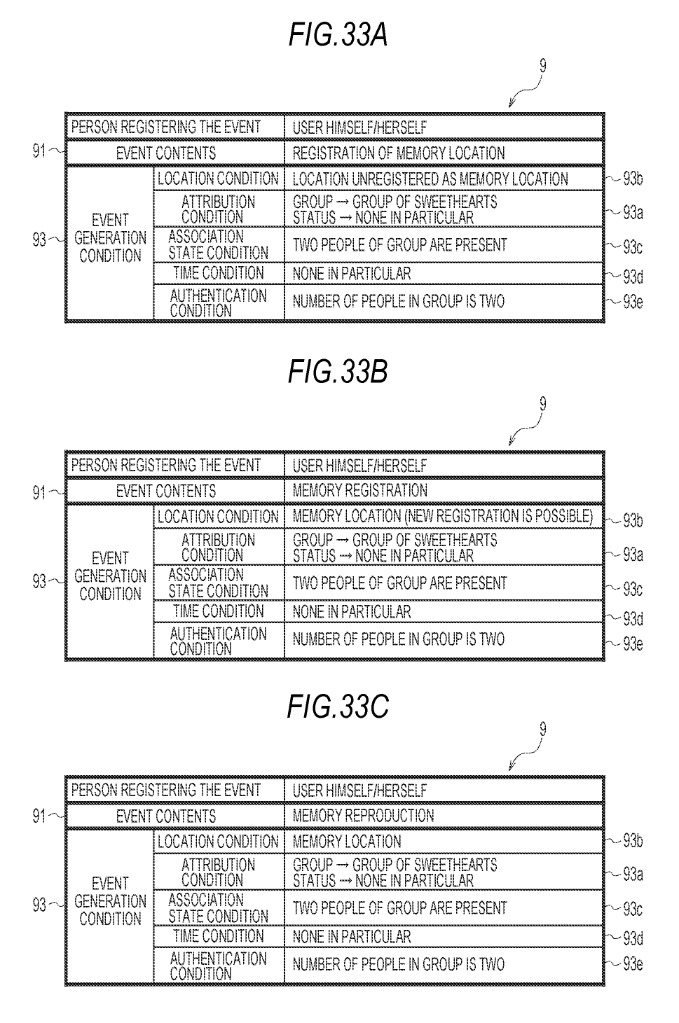

FIG. 33A to FIG. 33C illustrate an example of event information 9 registered in the case where the system according to the present embodiment is applied to a shared notebook system. In the shared notebook system, a common online notebook service is provided to a plurality of users (joint owners). The shared notebook can be shared, for example, by sweethearts, husband and wife, and members of a family.

According to this example, by generating an event relating to the event information 9 illustrated by FIG. 33A, the users who are the joint owners (for example, sweethearts) in the user attribution 8a can register a location that is visited at the same time by a plurality of joint owners (in the case of sweethearts, two people) as the location condition 93b of the event condition according to FIG. 33B and FIG. 33C. Further, by generating an event relating to the event information 9 illustrated by FIG. 33B in the registered location, it is possible to create “memory records” such as photos+annotations, comments, AR tags, and SNS posts at the memorable locations (event contents 91 illustrated by FIG. 33B). By generating an event relating to the event information 9 illustrated by FIG. 33C when a plurality of joint owners are again simultaneously present at the registered location, it is possible to send an alert notice (notification) and “reproduce memories” (event contents 91 illustrated by FIG. 33C) by viewing the photos or SNS posts that have been placed in the “memory records” created in the previous visit. The “memory records” of the event contents 91 illustrated by FIG. 33B can be generated when the registered location is visited again by a plurality of joint owners and the “memory records” such as photos+annotations, comments, AR tags, and SNS posts can be added.

### (Information Distribution System)

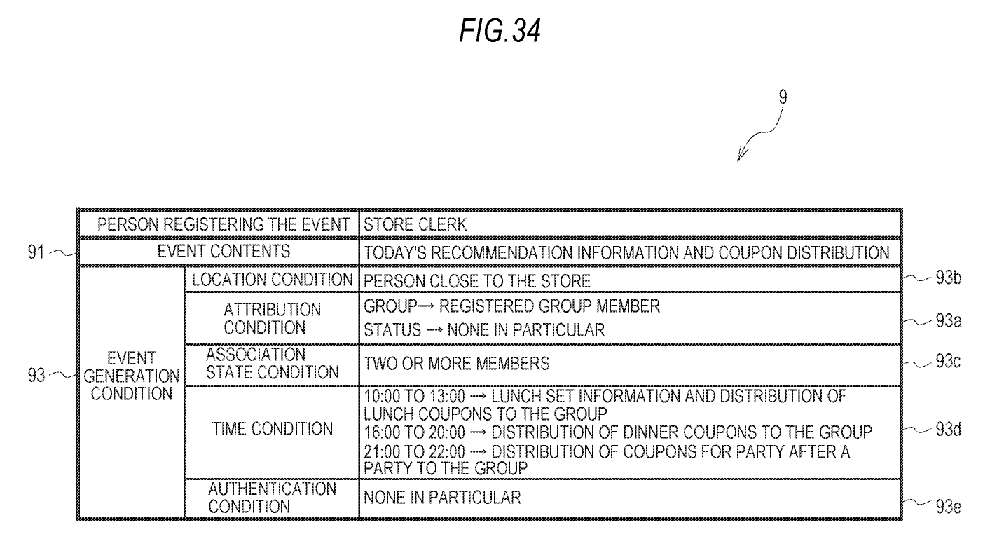

FIG. 34 illustrates an example of the event information 9 registered in the case where the system according to the present embodiment is applied to an information distribution system.

In this example, initially, a group including a plurality of users that has together visited a store (restaurant and the like) is registered by the users when the store that is set in the location condition 93b is visited. The user can create a group of SNS 3 by designating identification information in the SNS 3 of the users who belong to the group by using the user terminal 5 and transmitting the information to the SNS 3. In such a case, when two or more (not necessarily all the members) members of the group again happen to be in the vicinity of the restaurant, an event relating to the event information 9 illustrated by FIG. 34 is generated and “today's recommendation information and coupon distribution” can be performed for the group.

In the event information 9 illustrated by FIG. 34, a plurality of time conditions 93d are set, and the coupons that will be distributed differ depending on which time condition 93d is satisfied. In the event generation condition determination processing explained with reference to FIG. 14, it is determined whether or not the attribution condition 93a, the location condition 93b, the association state condition 93c, the time condition 93d, and the authentication condition 93e included in the event generation condition 93 associated with the event are satisfied, but it is also possible to set a plurality of branches in each of the conditions and introduce variations in the generated event on the basis of the branching results. For example, in the example illustrated by FIG. 34, the contents of the coupons to be distributed vary depending on whether the time condition 93d is satisfied and also depending on which of the three time conditions 93d (10:00 to 13:00, 16:00 to 20:00, and 21:00 to 22:00) is satisfied.

### <Effect>

With the system according to the present embodiment, it is possible to increase flexibility, while ensuring safety, in a system that controls an event by using position information.

What is claimed is:

1. An information processing apparatus comprising:
a user information acquisition unit to acquire user information including at least any one of user attribution information, position information indicating a present position of the user, and a state of a predetermined user association to which the user belongs;
a determination unit to determine whether or not the attribution information, the position information, and the state of the predetermined user association satisfy a condition associated with a predetermined event; and
an event control unit to allow or instruct generation of the predetermined event when the condition is determined by the determination unit to be satisfied.

2. The information processing apparatus according to claim 1, wherein
the state of the predetermined user association is obtained on the basis of at least either of the attribution information and the position information relating to another user.

3. The information processing apparatus according to claim 1, wherein
the state of the predetermined user association is at least either of the number of users for which the attribution information or the position information satisfies a predetermined condition, and a state in which the position information on a predetermined user satisfies a predetermined condition.

4. The information processing apparatus according to claim 1, wherein the determination unit determines the position information based on a location condition that has been set for each user or each user combination.

5. The information processing apparatus according to claim 1, wherein
the user information acquisition unit further acquires at least either of a present time and user authentication information; and
the determination unit determines whether at least either of the present time and the authentication information, in addition to the attribution information, the position information, and the state of the predetermined user association, satisfies the condition.

6. The information processing apparatus according to claim 1, wherein
contents of the predetermined event is encoded; and
the event control unit allows or instructs the generation of the predetermined event by issuing a decoding key for decoding the encoded contents of the predetermined event.

7. An event control method for causing a computer to execute:
acquiring user information including at least any one of user attribution information, position information indicating a present position of the user, and a state of a predetermined user association to which the user belongs;
determining whether or not the attribution information, the position information, and the state of the predetermined user association satisfy a condition associated with a predetermined event; and
allowing or instructing generation of the predetermined event when the condition is determined in the determining to be satisfied.

8. A computer-readable non-transitory recording medium having stored therein an event control program for causing a computer to function as:
a user information acquisition unit to acquire user information including at least any one of user attribution information, position information indicating a present position of the user, and a state of a predetermined user association to which the user belongs;
a determination unit to determine whether or not the attribution information, the position information, and the state of the predetermined user association satisfy a condition associated with a predetermined event; and
an event control unit to allow or instruct generation of the predetermined event when the condition is determined by the determination unit to be satisfied.
